(19) United States
(12) Patent Application Publication
(10) Pub. No.: US 2013/0172408 A1
(43) Pub. Date: Jul. 4, 2013

(54) Medicaments Based on Dinuclear Arene Ruthenium Complexes Comprising Bridging Thiolato, Selenolato or Alkoxo Ligands

(71) Applicants: Georg Suss-Fink, Neuchatel (CH); Bruno Therrien, Corvaux (CH); Michael Gras, Neuchatel (CH); Paul Joseph Dyson, Ecublens (CH); Olivier Zava, Neuchatel (CH); Anne-Flore Ibao, Neuchatel (CH)

(72) Inventors: Georg Suss-Fink, Neuchatel (CH); Bruno Therrien, Corvaux (CH); Michael Gras, Neuchatel (CH); Paul Joseph Dyson, Ecublens (CH); Olivier Zava, Neuchatel (CH); Anne-Flore Ibao, Neuchatel (CH)

(73) Assignee: Universite de Neuchatel, Neuchatel (CH)

(21) Appl. No.: 13/810,932

(22) PCT Filed: Jul. 19, 2011
(86) PCT No.: PCT/EP11/62396

§ 371 Date: Mar. 8, 2013

(30) Foreign Application Priority Data
Jul. 20, 2010 (EP) 10170125.8

(51) Int. Cl. C07F 15/00

(52) U.S. Cl. CPC C07F 15/0046
USPC 514/492

(57) ABSTRACT

The present invention provides new complexes and medicaments based on dinuclear ruthenium complexes comprising bridging thiolato or selenolato ligands. The complexes comprise a Ru₂X₃ or a Ru₂X₂ core, in which each one of said X is independently selected from said bridging ligands, with the proviso that at least one ligand comprises a substituted or unsubstituted phenyl moiety.

### TECHNICAL FIELD

The present invention relates to complexes for use as medicaments and/or as catalysts. The complexes are based on dinuclear ruthenium and osmium complexes comprising bridging thiolato, selenolato and/or alkoxo ligands. The complexes, which are preferably provided as cations along with a pharmaceutically acceptable anionic species or as neutral complexes, are particularly useful in the treatment of hyperproliferative disorders, in particular cancer.

### PRIOR ART AND THE PROBLEM UNDERLYING THE INVENTION

Cancer is the second leading cause of death in economically developed countries and the third leading cause of death in developing countries. Statistically, one in eight Europeans will develop cancer during his or her lifetime. Although estimated incidence rates show rising trends for both sexes, the age-standardized cancer mortality rate has been falling continuously among women since 1970 and among men since 1985. The increase of the survival rates is due to better cancer treatment, in particular thanks to the introduction of efficient anticancer drugs which largely contributed to this improvement.

Platinum-based drugs have been in clinical use for cancer treatment for more than 30 years. The landmark discovery of the antitumoural properties of cis-diamminedichloroplatinum(II) (cisplatin) by Rosenberg in 1965 heralded a new area of anticancer research based on metallopharmaceuticals. To date, cisplatin and its analogues are some of the most effective chemotherapeutic agents in clinical use. However, platinum-based drugs are not without problems: their high toxicity and incidence of drug resistance remain the main challenges in their clinical application.

In the search of anticancer agents containing metals other than platinum (thus overturning the platinum paradigm), ruthenium compounds turned so far out to be the most promising ones, but high activity of other metal compounds should not be excluded at the present stage.

A detailed review on the use of arene ruthenium complexes as anticancer agents was recently published by G. Süss-Fink, Dalton Trans., 2010, 39, 1673-1688.

In WO 02/40494, ruthenium-based complexes containing a 1,3,5-triaza-7-phosphaadamantane ligand were shown to induce cell death by apoptosis of SK-N-SH neuroblastoma cells, derived from human metastases at concentrations of the sub micromolar range.

In WO 2007/128158, inhibitors of resistance pathways, such as ethacryinic acid, were coupled to ruthenium-based complexes and were shown to be particularly useful in the prevention of metastasis.

WO 2009/013724 discloses high toxicity of trinuclear arene ruthenium clusters on A2780 ovarian cancer cell lines.

Mendoza-Ferri et al., Organometallics 2008, 27, 2405-2407 found high cytotoxic effects of water-soluble dinuclear arene ruthenium complexes. In this study, the length of a spacer linking two pyridinone ligand moieties was shown to have an important impact on the toxicity, with higher spacer length resulting in higher toxicity.

In JP 7089855 and JP 7089974 dinuclear pentamethylcyclopentadienyl ruthenium(III) complexes of the type [(η⁵-C₅R₅)₂Ru₂(SR)₃]⁺ are disclosed, in which R generally represents a phenyl or substituted phenyl. While these complexes are indicated to be toxic towards human liver cancer cells, the toxicity does not seem to be very high. In view of these prior art documents it is an objective to obtain other complexes possibly exhibiting higher activities.

Very few, if any, of the compounds and complexes of the prior art cited above have resulted in clinical phase studies, not to mention actual therapies. The reasons for the poor performance of these principles are manifold and may be linked to toxicity problems or un-sufficient efficiency in treatment.

It is thus an objective of the present invention to explore new ways for treating cancer, for example based on work done in the area of complexes of transition metals.

It is a further aspect of the present invention to increase the activity and/or efficiency of therapies against diseases and in particular cancer.

Considering the incidence of resistance against current therapies, it is also an objective to find new principles exhibiting toxicity against cancer cells, possibly toxic against cells that are resistant to existing therapies.

It is also an objective to provide active principles exhibiting fewer side effects than therapies of the prior art.

It is an objective to provide compounds which are still more cytotoxic against cancer cells.

It is a particular objective to provide further ruthenium-based organometallic compounds that are at least as effective as or even more effective than the organometallic compounds known so far.

The present invention addresses the problems depicted above.

### SUMMARY OF THE INVENTION

Remarkably, the inventors provide dinuclear arene ruthenium and osmium complexes comprising bridging thiolato, selenolato or alkoxo ligands, and demonstrate surprisingly high toxicity of such complexes against cancer cells.

The complexes preferably comprise a M₂X₃ or M₂X₂ core, in which M is a metal atom selected from Ru and Os and each one of said three X is independently selected from said bridging ligands, wherein at least one ligand preferably comprises a substituted or unsubstituted aryl moiety. In addition, a substituted or unsubstituted arene is preferably bound as a η⁶ ligand to each metal atom.

In an aspect, the present invention provides a complex of, or comprising, the structure of any one of formulae (Ia) and/or (Ib):

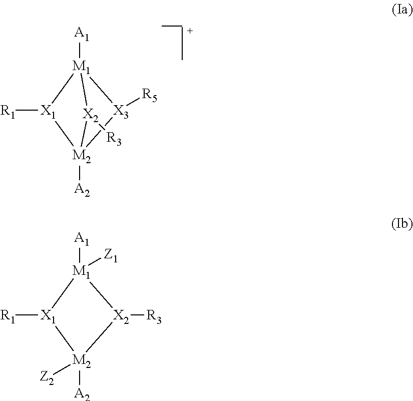

wherein M₁ and M₂ are metal atoms selected independently from Ru and Os;
wherein A₁ and A₂ are arenes bound as η⁶ ligands to the metal atoms M₁ and M₂, respectively, said arenes being selected from substituted or unsubstituted benzene and substituted or unsubstituted polycycles of up to three rings and comprising at least one benzene ring;
   wherein said substituents, if present, may be selected from C1-C20 hydrocarbons optionally comprising 0-15 heteroatoms, halogens, hydroxyl, carboxylic acid group, carbonyl, nitro and amino;
wherein X₁, X₂, and X₃ are, independently, selected from S, Se, and O;
wherein, if any one of X₁, X₂, and X₃ is other than N, R₂, R₄, and R₆, respectively, is/are absent;
Z₁ and Z₂ are independently selected from halogen (F, Cl, Br, I, preferably Cl);
wherein R₁, R₃, and R₅, in as far as present, are selected, independently, from H, and from C1-C30 hydrocarbons optionally comprising 0-20 heteroatoms.

According to an embodiment, said C1-C30 hydrocarbons optionally comprising 0-20 heteroatoms, with respect to R₁, R₃, and R₅, in as far as present, are selected from:

substituted or unsubstituted aryls;
substituted or unsubstituted aliphatic substituents; and
substituents derived independently from a natural compound and/or a bioactive compound; wherein substituents of said aryl and aliphatic substituent, if present, may be selected independently from C1-C20 hydrocarbons comprising 0-15 heteroatoms, halogens, hydroxy, carboxylic acid group, nitro and amino, and wherein two substituents provided on different carbons of said aryl or aliphatic substituent may be connected so as to form one or more ring fused to said aryl or aliphatic substituent.

In an aspect, the present invention provides a complex for use as a medicament, the complex comprising the structure of any one selected from formulae (IIa) and/or (IIb):

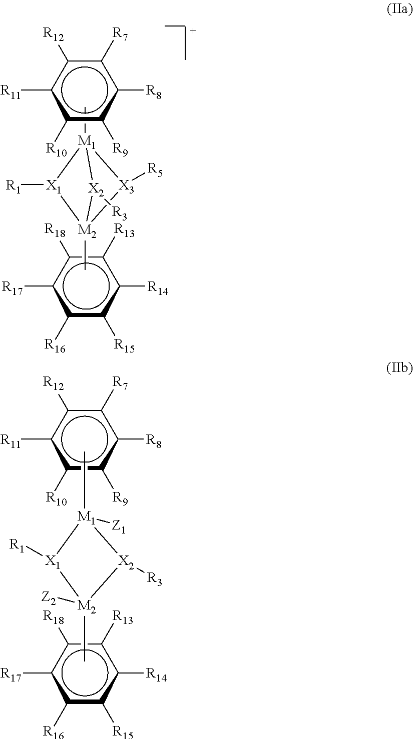

wherein M₁ and M₂ are a Ru(II) metal atoms;
wherein R₇, R₈, R₉, R₁₀, R₁₁, R₁₂, R₁₃, R₁₄, R₁₅, R₁₆, R₁₇, and R₁₈ are independently selected from H and from C1-C20 hydrocarbons optionally comprising 0-15 heteroatoms, halogens, hydroxyl, carboxylic acid group, carbonyl, nitro and amino, wherein substituents on two neighbouring carbons of any one or both of the benzene rings in formulae (IIa) and (IIb) may form a ring fused to the benzene ring;
   wherein X₁, X₂, and X₃ are, independently, selected from S, Se, and O;
   Z₁ and Z₂ are independently selected from halogen;
   wherein R₁, R₃, and R₅, in as far as present, are selected, independently, from H, and from C1-C30 hydrocarbons optionally comprising 0-20 heteroatoms, said hydrocarbons being selected from:
   substituted or unsubstituted aryls;
   substituted or unsubstituted aliphatic substituents; and
   substituents derived independently from a natural compound and/or a bioactive compound;
      wherein substituents of said aryl and aliphatic substituent, if present, may be selected independently from C1-C20 hydrocarbons comprising 0-15 heteroatoms, halogens, hydroxy, carboxylic acid group, nitro and amino, and wherein two substituents provided on different carbons of said aryl or aliphatic substituent may be connected so as to form one or more ring fused to said aryl or aliphatic substituent.

According to an aspect of the invention, the complex is a cationic complex and is preferably provided together with a pharmaceutically acceptable anionic species.

In an aspect, the present invention provides complexes of the invention for use as a medicament, and/or for use in a therapeutic and/or prophylactic method.

In an aspect, the invention provides a pharmaceutical composition comprising the complex of the present invention.

In an aspect, the present invention provides complexes of the invention for use in the treatment of hyperproliferative disorders, in particular cancer.

In an aspect, the present invention provides the use of the complexes of the invention in the preparation of a medicament against hyperproliferative disorders, in particular cancer.

In an aspect, the present invention provides a method for the treatment and/or prophylaxis.

The method preferably comprises the step of administering, to a person in need thereof, in particular a person suffering from one or more of the conditions specified in the detailed description, the complex of the present invention. Preferably, an effective amount of the complex is administered. Preferably, a condition is treated or prevented, such as a hyperproliferative disorder, in particular cancer.

In an aspect, the present invention provides the use of the complexes of the invention as a catalyst.

In an aspect, the present invention provides a method of catalyzing the oxidation of free —SH groups in compounds comprising said group, the method comprising the step of exposing said compound to the complex of the invention.

Further aspects, embodiments, features and advantages of the invention will become apparent to the skilled person from the detailed description below.

### BRIEF DESCRIPTION OF THE DRAWINGS

FIG. 1 shows two reaction schemes illustrating the synthesis of diene precursors 1-4 used for the preparation of complexes according to the invention.

FIG. 2 shows reaction schemes illustrating the synthesis of functionalised arene ruthenium chloro intermediates 5-8, which are used in the preparation of complexes according to the invention.

FIG. 3 shows reaction schemes illustrating the synthesis of functionalised ruthenium thiophenolato complexes 9-12 encompassed by the present invention.

FIG. 4 shows reaction schemes illustrating the synthesis of the functionalised arene ruthenium hydroxythiophenolato complexes 13-16 encompassed by the present invention.

FIG. 5 shows a reaction scheme illustrating the synthesis of unfunctionalised cationic diruthenium complex 17, a complex according to a preferred embodiment of the present invention.

FIG. 6 shows diruthenium complexes 19 (left) and 20 (right), which are cationic complexes according to embodiments of the present invention, wherein complex 20 is a preferred embodiment of the invention.

FIG. 7 shows the molecular structure of cation 17, a complex according to an embodiment of the invention. Thermal ellipsoids are drawn at 50% probability level and hydrogen atoms are omitted for clarity.

FIG. 8 shows a reaction scheme illustrating the synthesis of neutral dinuclear complexes according to an embodiment of the present invention.

FIGS. 9A and 9B show exemplary and preferred complexes of the present invention.

### DETAILED DESCRIPTION OF THE PREFERRED EMBODIMENTS

The present invention provides novel complexes and complexes for use in prophylactic and therapeutic applications.

According to an embodiment, the complex of the invention is of, or comprises, a structure of any one complex of formulae (Ia) or (Ib)

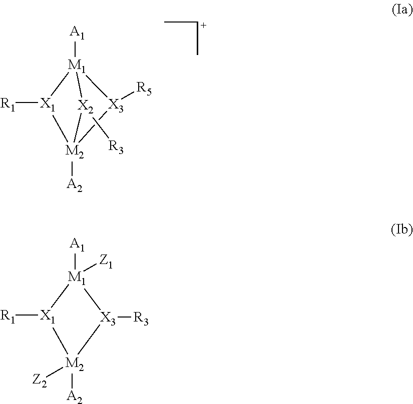

wherein M₁ and M₂ are metal atoms selected independently from Ru and Os;
wherein A₁ and A₂ are arenes bound as η-6 ligands to the metal atoms M₁ and M₂, respectively, said arenes being selected from substituted or unsubstituted benzene and substituted or unsubstituted polycycles of up to three rings and comprising at least one benzene ring;
   wherein said substituents, if present, may be selected from C1-C20 hydrocarbons optionally comprising 0-15 heteroatoms, halogens, hydroxyl, carboxylic acid group, carbonyl, nitro and amino;
      wherein X₁, X₂, and X₃ are, independently, selected from S, Se, and O;
      wherein Z₁ and Z₂ are independently selected from halogen;
wherein R₁, R₃, and R₅, in as far as present, are selected, independently, from H, and from C1-C30 hydrocarbons optionally comprising 0-20 heteroatoms, said hydrocarbons being selected from:
   substituted or unsubstituted aryls;
   substituted or unsubstituted aliphatic substituents; and
   substituents derived independently from a natural compound and/or a bioactive compound;
      wherein substituents of said aryl and aliphatic substituent, if present, may be selected independently from C1-C20 hydrocarbons comprising 0-15 heteroatoms, halogens, hydroxy, carboxylic acid group, nitro and amino, and wherein two substituents provided on different carbons of said aryl or aliphatic substituent may be connected so as to form one or more ring fused to said aryl or aliphatic substituent.

For the purpose of the present specification, the term “comprise”, or “comprising” is intended to mean “includes, amongst others” and is not intended to mean “consists only of”.

In the terms of the present specification and the appended claims, the expression “selected from”, may, according to an embodiment, be interpreted as “selected from the group consisting of”, if applicable in the context, in particular if followed by a specific list of options.

“Heteroatoms”, for the purpose of the present specification, may be selected from any atom other than carbon and hydrogen. According to an embodiment, metal atoms are excluded, preferably, alkali metals are excluded, even more preferably, transition metals are also excluded. According to a preferred embodiment, heteroatoms are selected from non-metals, in particular from B, N, P, As, O, S, Se, and from halogen, halogen encompassing preferably F, Cl, Br, and I. According to a preferred embodiment, heteroatoms are selected from N, O, S, and halogen. Heteroatoms other than halogen may, if applicable, replace a carbon atom within a hydrocarbon molecule, for example in a carbon chain or in a ring. Such heteroatoms are preferably selected from N, O and S.

According to a preferred embodiment, M₁ and M₂ are both the same metal. According to an embodiment, the metals M₁ and M₂ are in the (II+) oxidation state. Preferably, M₁ and/or M₂ are Ru. Most preferably, said Ru atoms are in the Ru(II)-oxidation state (Ru(II)).

X₁, X₂, and X₃ may be selected independently from S, Se, and O.

According to a preferred embodiment, X₁, X₂, and X₃ are all the same.

Preferably, X₁, X₂, and X₃ are selected independently from S, Se, and O, more preferably from S and Se. Most preferably X₁, X₂, X₃ all are sulfur atoms.

According to an embodiment, at least one, preferably at least two, and more preferably at least three of substituents R₁, R₃, and R₅, in as far as present, are different from H.

Z₁ and Z₂ are selected from halogen, preferably Cl, Br, I, most preferably Cl.

In the complex of the invention, R₁, R₃, and R₅, in as far as present, are selected, independently, from H, and from C1-C30 hydrocarbons optionally comprising 0-20 heteroatoms, as further defined in this specification. Preferably, said hydrocarbon is a C2-C20 hydrocarbon comprising 0-10 heteroatoms, more preferably a C3-C15 hydrocarbon comprising 0-8 heteroatoms and most preferably a C6-C10 hydrocarbon comprising from 0-3 heteroatoms.

In accordance with an embodiment of the invention, R₁, R₃, and R₅, in as far as present, may be selected from substituted or unsubstituted aryls. Aryls may be selected from heteroaryls or aryls lacking heteroatoms. Aryls are preferably selected from C6-C12 aryls and more preferably from phenyl and naphtyl. Preferred substituents of said aryl are as defined elsewhere in this specification and may be selected, independently, from the same substituents as those of said aliphatic substituents.

In accordance with an embodiment of the invention, R₁, R₃, and R₅, in as far as present, may be selected from substituted or unsubstituted aliphatic substituents. Said aliphatic substituent is preferably selected from C1-C10 alkyl, C2-C10 alkenyl, C2-C10 alkynyl, wherein said alkyl, alkenyl and alkynyl, if it comprises at least three carbons, may be linear, branched and/or cyclic and may be substituted, and wherein, in said alkyl, alkenyl and alkynyl, one or more carbons may be replaced by heteroatoms. Although this is encompassed by the invention, preferably, however, in said alkyl, alkenyl, and alkynyl, no carbon is replaced by a heteroatom. It is noted that substituents of said aliphatic substituent may not be aliphatic but aromatic. Preferred substituents of said aliphatic substituents are as defined elsewhere in this specification and may be the same as for said aryl substituents.

According to an embodiment, X, X₂ and X₃ are, in as far as present, selected from S, Se, and O, preferably from S and Se, R₁, R₃, and R₅, in as far as present, are selected from substituted or unsubstituted C6-C12 aryls, (in particular phenyl and naphthyl) and C1-C10 linear, branched or cyclic alkyls, wherein said aryls and alkyls may be further substituted, as specified elsewhere in this specification and in particular below as halogen and substituents —R₃₀; and —O—R₃₀ (see further below).

In R₁, R₃, and R₅, in as far as present, substituents of said aryl and aliphatic substituents, if present, may be selected, independently, from C1-C20 hydrocarbons optionally comprising 0-15 heteroatoms, preferably C1-C15 hydrocarbons optionally comprising 0-10 heteroatoms, more preferably C1-C10 hydrocarbons comprising 0-5 heteroatoms, even more preferably C1-C5 hydrocarbons comprising 0-3 heteroatoms.

According to a preferred embodiment, in said R₁, R₃, and R₅, in as far as present, said aryl is a substituted or unsubstituted phenyl; said aliphatic substituent is selected from C1-C10 alkyl, C2-C10 alkenyl, C2-C10 alkynyl, wherein said alkyl, alkenyl and alkynyl may be further substituted and may be linear and, if it comprises at least three carbons, also branched and/or cyclic and, and wherein, in said alkyl, alkenyl and alkynyl, one or more carbons may be replaced by heteroatoms; wherein substituents of said phenyl, alkyl, alkenyl, and alkynyl, if present, may be independently selected from: C1-C20 hydrocarbons optionally comprising 0-15 heteroatoms, or preferred hydrocarbon substituents as mentioned above.

In an embodiment, if R₁, R₃, and R₅ is an aryl or a cyclic aliphatic substituent (such as a cyclic alkyl, alkenyl or alkynyl, for example, as defined above), substituents of said aryl and cyclic aliphatic substituent may be connected to each other to form a ring, which may be, for example, fused to said aryl or cyclic aliphatic substituent.

According to a preferred embodiment, with respect to R₁, R₃, and R₅, in as far as present, said optional substituents of said aryl (preferably: phenyl), alkyl, alkenyl, and alkynyl, if present, are selected from: halogen; —R₃₀; —O—R₃₀; —O—R₃₅; wherein R₃₀ is independently selected from C1-C8 alkyls, C2-C8 alkenyls, and C2-C8 alkynyls, which, independently, may be linear, and if comprising more than three carbons, branched or cyclic, and which may be totally or partially halogenated, and from substituents of formula (V) below:

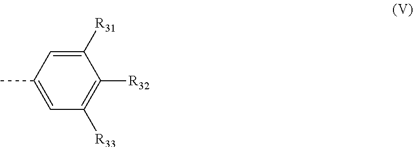

wherein R₃₅ is derived from a C3-C20 hydrocarbon compound comprising 1 to 15 heteroatoms, said compound being selected from natural compounds and bioactive compounds comprising at least one carboxylic acid group forming, in said substituent R₃₅, an ester bond with the oxygen atom of said —O—R₃₅ substituent; wherein R₃₁, R₃₂, R₃₃ are, independently, selected from: H; halogen; C1-C8 alkyl, C2-C8 alkenyl, C2-C8 alkynyl, which may linear or, if comprising three or more carbons, branched and cyclic, wherein said alkyls, alkenyls and alkynyl may be totally or partially halogenated; and, substituents —O—R₃₅. According to an embodiment, said C1-C8 alkyl, C2-C8 alkenyl, C2-C8 alkynyl are selected from C1-C4 alkyls, C2-C4 alkenyls and C2-C4 alkynyls, respectively. R₃₁, R₃₂, R₃₃ may, independently, also be selected phenyl, which may be totally or partially halogenated.

According to a preferred embodiment, if R₁, R₃, and R₅, in as far as present, are selected from substituted or unsubstituted C6-C12 aryls (in particular phenyl and naphthyl), including heteroaryls, and C1-C10 linear, branched or cyclic alkyls, said optional substituents of said aryl and alkyl, if present may be selected from —OH, —COOH, halogen, —R₃₀; and —O—R₃₀, and from substituents of formula (V), wherein —R₃₀ is selected from C1-C8 alkyls, and R₃₁, R₃₂, R₃₃ are, independently, selected from: H; halogen; C1-C8 alkyl, linear or cyclic C2-C8 alkenyl, and wherein substituents of said aryl and cyclic alkyl may be connected to each other to form a ring, which may be, for example, fused to said aryl or cyclic aliphatic substituent.

According to an embodiment, R₃₅ is derived from any one compound selected from isonicotinic acid, ethacrynic acid, folic acid, biotin, pyridoxol-5-phosphate hydrate, wherein any carboxylic acid group of said compound forms an ester bond with the oxygen atom of the —O—R₃₅ substituent.

According to an embodiment, R₁, R₃, and R₅ are selected from substituents of formula (Va):

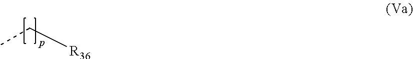

wherein p is selected from 0 and from the integers of 1-5, preferably from 0, 1, 2 and 3, most preferably from 0 and 1;

R₃₆ is selected from H, C1-C10 linear or branched alkyl or alkoxyl, C5-C10 cycloalkyl, C2-C10 linear, branched or cyclic alkenyl, C₆-C16 aryl (including heteroaryls) and, wherein said alkyl, alkenyl, aryl and cycloalkyl may be further substituted, wherein further substitutents are selected from halogens, —OH, —COOH, and from C1-C12, preferably C₁₋₆ hydrocarbons comprising one or more heteroatoms, wherein, if R₃₆ is a cyclic moiety (aryl, cyclic alkyl and alkenyl), substituents on neighbouring carbons of said cyclic moiety may form one or more further cycles fused to said cyclic moiety.

According to a preferred embodiment, R₃₆ is selected from H, phenyl, 2-furyl, cyclohexyl, naphthyl, C1-C4 alkyl, and optional substituents of said phenyl, 2-furyl, cyclohexyl, naphthyl, C1-C4 alkyl may be selected from halogen, phenyl, C1-C4 alkyl, naphthyl, C1-C4 alkoxyl, —COOH, and —OH.

More preferably, R₃₆ is selected from phenyl, naphthyl and cyclohexyl, and optional substituents are selected from C1-C4 alkyl, alkoxyl, phenyl and halogen. Most preferably, p=1.

In accordance with the invention and embodiments thereof, wherein R₁, R₃, and R₅, in as far as present, may be, independently, a substituent derived from a natural compound and/or a bioactive compound.

According to an embodiment, if said substituents R₁, R₃, and/or R₅, in as far as present, is derived from a natural compound and/or bioactive compound, said natural and/or bioactive compound, when not yet bound in the complex of the invention, comprises at least one group selected from HS—, HSe—, and HO— (said group being, for the purpose of the present specification and with respect to substituents R₁, R₃, and/or R₅, a “ligand group”, as it forms said thiolato, selenolato and/or alkoxo ligand in the complex of the invention), or wherein said natural or bioactive compound is covalently connected to a linker moiety comprising one of the aforementioned ligand groups, the linker moiety comprising, preferably consisting of, said ligand group included, 1-10 carbons and 1-5 heteroatoms, and wherein, in said substituent derived from a natural compound and/or a bioactive compound, the sulphur, selenium, or oxygen atom of said HS—, HSe—, HO—, respectively, constitutes one or more of X₁, X₂, and X₃ in the complex. In other words, the S, Se, or O of said HS-, HSe-, or HO-group, respectively, of said natural or bioactive compound or of said linker forms said thiolato, selenolato, or alkoxo ligand, with said H of said ligand group being removed.

Preferably, said linker moiety comprises, said group included, 1-5 carbons and 1-4 heteroatoms, more preferably 1-3 carbons and 1-2 heteroatoms.

Examples of natural compounds for the purpose of this specification (also with respect to —O—R₃₅) are naturally occurring carbohydrates; such as mono-, di-, and polysaccharides; amino acids and peptides, such as di-, tri-, oligo-, and polypeptides; lipids, such as fatty acids, phospholipids, ceramides and other sphingolipids, such as aphingoglycolipids; terpenes, in particular sesqui-, mono-, di-, sester-, tri-, tetra-, and polyterpenes; alkaloids; lipoproteins; glycolipids, such as glyceroglycolipids; glycoproteins, just to mention a few.

Specific natural and bioactive compounds are as listed further above with respect to —R₃₅

For example, a carboxylic acid group of such a natural or bioactive compound may be esterified with a hydroxyl group provided on the linker, and the ligand group of said linker thus providing said bivalent thiolato, selenolato, and/or alkoxo ligand to metal M₁ and M₂ with substituent R₁, R₃, and/or R₅, as applicable.

According to a preferred embodiment, said bioactive moiety or said natural or bioactive compound is a compound comprising a thiol or a selenol group. When said bioactive or natural compound forms a hydrocarbon substituent in the compound of the invention (X₁—R₁, X₂—R₃, and/or X₃—R₅), the sulphur or selenium atom of said thiol or selenol group is the sulphur or selenium atom of the thiolato or selenolato ligand, respectively, by which the bioactive or natural compound is bound to the metal M₁ and M₂.

Examples of natural or bioactive compounds comprising free thiol or selenol groups and which could be used as thiolato or selenolato ligand (S—R_{1/3/5}; Se—R_{1/3/5}), for example, may be selected from cysteine, selenocysteine, peptides comprising a cysteine or selenocysteine moiety, thioglucose, for example.

According to a preferred embodiment, at least one, preferably at least two, and, according to an embodiment, all three of R₁, R₃ and R₅ are selected independently from substituted and unsubstituted aryl, in particular phenyl, wherein substituents of said aryl (for example, phenyl), may be selected, independently as defined elsewhere in this specification, in particular from phenyl, and C1-C4 alkyl, wherein said C1-C4 alkyl may be linear or branched if it has more than two carbons.

According to an embodiment, one, two, three or more substituents of R₁, R₃, and R₅, in as far as present, are H or hydrocarbons as defined elsewhere in this specification, with the proviso that they are free of any heteroatom and/or that definitions of substituents that do not contain any heteroatom are encompassed, independently from the other substituents R₁, R₃, and R₅.

In particular, said optionally substituted aryl or aliphatic substituents are preferably free of heteroatoms, whereas substituents thereof may contain heteroatoms, but are preferably also free of heteroatoms.

According to an embodiment, one, two, three or more of R₁, R₃, and R₅, in as far as present, are selected from H and hydrophobic substituents.

As mentioned above, A₁ and A₂ in formulae (Ia) and (Ib) above are arenes bound as η⁶ ligands to the metal atoms M₁ and M₂, respectively, said arenes being selected from substituted or unsubstituted benzene and substituted or unsubstituted polycycles of up to three rings and comprising at least one benzene ring. Substituents of A₁ and A₂, if present, may be selected from C1-C20 hydrocarbons optionally comprising 0-15 heteroatoms, halogens, hydroxyl, carboxylic acid group, carbonyl, nitro and amino. The carboxylic acid group may be further substituted, for example alkylated.

A₁ and A₂ may be the same or may be different. According to a preferred embodiment, A₁ and A₂ are the same, that is, are substantially identical.

It is noted that the substituents of the arene A₁ and A₂ do not seem to have a huge impact on the activity of the complexes, which is why substituents may be selected from a large group of substituents. It is thus not excluded to provide additional functionalities on the arene ring, such as, for example, disclosed in WO2007/128158, in particular on page 9, line 25 to page 11, line 21 of the published international application. There, the possibility of a bioactive compound bound to the arene is also encompassed. WO2007/128158 is entirely incorporated herein by reference.

According to a preferred embodiment, A₁ and A₂ are, independently, selected from arenes of formula (VI) below:

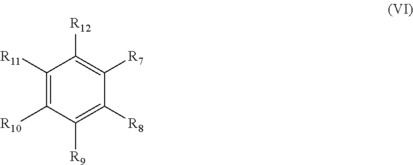

wherein R₇, R₈, R₉, R₁₀, R₁₁, and R₁₂, are independently selected from H and C1-C20 hydrocarbons optionally comprising 0-15 heteroatoms, halogens, hydroxyl, carboxylic acid group, carbonyl, nitro and amino. The carboxylic acid group may be further substituted, for example alkylated. Different substituents may be may be linked so as to form one or more rings fused to said benzene ring. Preferably, substituents of neighbouring carbons of the benzene rings may be linked so as to form a ring fused to said benzene ring. The ring fused to the benzene may form a polycyclic arene, such as naphthalene, indene, anthracene phenantrene, biphenylene, and the like, for example.

According to an embodiment, A₁ and A₂ are, independently, selected from arenes of formulae (VI), (VII), (VIII), (IX), (X), (XI) and (XII) below:

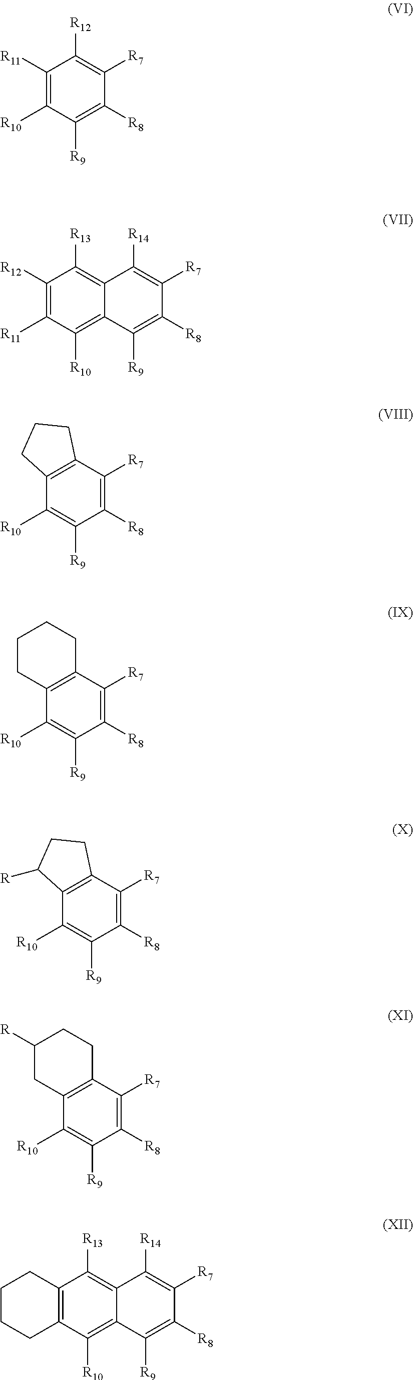

wherein R, R₇, R₈, R₉, R₁₀, R₁₁, R₁₂, R₁₃, R₁₄, are as R₇ to R₁₂, defined above.

The arenes of formulae (VIII) to (XII), are examples in which substituents R₁₁ and R₁₂ are linked so as to form a ring fused to the benzene ring. Arene (VII) is substituted or unsubstituted naphthalene, an example for a substituted or unsubstituted polycycle. Arene (XII) is the same as (VII), in which substituents R₁₁ and R₁₂ are linked (covalently) so as to form a system comprising a ring fused to the naphthalene ring system.

Since A₁ and A₂ may be the same or may be different, and since the substituents on A₂ may be selected independently from those on A₁, it can be said that A₁ may be selected of arenes of formula (VI) below and A₂ may be selected of arenes of formula (XIII) below.

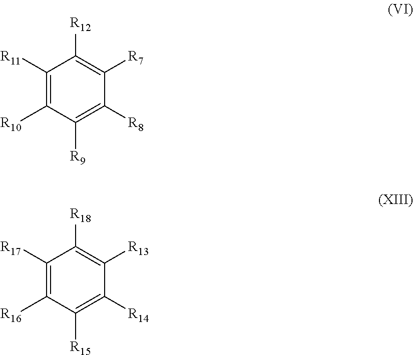

wherein R₇, R₈, R₉, R₁₀, Ru₁₁, R₁₂, R₁₃, R₁₄, R₁₅, R₁₆, R₁₇, and R₁₈ may be selected independently from substituents as defined for R₇ to R₁₂ with respect to formula (VI) above.

According to a preferred embodiment, R₇, R₈, R₉, R₁₀, R₁₁, R₁₂, R₁₃, R₁₄, R₁₅, R₁₆, R₁₇, and R₁₈ are independently selected from C4-C20 hydrocarbons optionally comprising 0-15 heteroatoms, with the proviso that said C4-C20 hydrocarbon optionally comprising 0-15 heteroatoms comprises at least one aromatic ring or ring system and/or comprises at least one bioactive moiety, and further from H, halogens, hydroxyl, carboxylic acid group, nitro and amino, C1-C10 alkyls, C2-C10 alkenyls, C2-C10 alkynyls, C4-C10 aryl, C1-C10 alkoxyl, C2-C10 alkenoxyl, C2-C10 alkynoxyl, C4-C10 aryloxyl, all of which may be totally or partially halogenated and wherein said alkyl, alkoxyl, alkenyl, alkenoxyl, alkynyl, alkynoxyl, may be linear or branched.

Any aryl and/or an aryl moiety of said aryloxyl mentioned herein, if it is a C4 or a C5 aryl and/or aryloxyl, respectively, it comprises at least one heteroatom. Said aryl and aryloxyl may be further substituted, besides with halogen, with C1-C4 alkyl, and wherein substituents on neighbouring carbons of the benzene ring may be linked so as to form one or more rings fused to said benzene ring.

According to a preferred embodiment, R₇, R₈, R₉, R₁₀, R₁₁, R₁₂, R₁₃, R₁₄, R₁₅, R₁₆, R₁₇, and R₁₈ are independently selected from H, halogens, hydroxyl, carboxylic acid group, nitro and amino, C1-C8 alkyls, C2-C8 alkenyls, C2-C8 alkynyls, C4-C8 aryl, C1-C8 alkoxyl, C2-C8 alkenoxyl, C2-C8 alkynoxyl, C4-C10 aryloxyl, wherein said alkyl, alkoxyl, alkenyl, alkenoxyl, alkynyl, alkynoxyl, and aryloxyl may be totally or partially halogenated and/or may be linear or branched, wherein, if said aryl and/or an aryl moiety of said aryloxyl, if it is a C4 or a C5 aryl and/or aryloxyl, respectively, it comprises at least on heteroatom, and wherein substituents on neighbouring carbons of the benzene ring may be linked so as to form one or more rings fused to said benzene ring. Said fused rings, may, of course, be further substituted, as far as other requirements as defined herein are met.

According to an embodiment, R₇, R₈, R₉, R₁₀, R₁₁, R₁₂, R₁₃, R₁₄, R₁₅, R₁₆, R₁₇, and R₁₈ are independently selected from H, C1-C5 alkyls, C2-C5 alkenyls, and C2-C5 alkynyls, wherein said alkyl, alkenyl and alkynyl may be linear or branched, and from —(CH₂)ₙ—O—C(O)—C₆H₄-p-O—(CH₂)ₘCH₃, —(CH₂)ₙ—O—C(O)—CH═CH—C₆H₄-p-O—CH₃, wherein m is, independently, an integer of 1-6 and n being, independently, 1, 2, 3 or 4.

According to an embodiment, R₇, R₈, R₉, R₁₀, R₁₁, R₁₂, R₁₃, R₁₄, R₁₅, R₁₆, R₁₇, and R₁₈ are independently selected from H, and C1-C4 alkyls.

In the most active compounds, R₇, R₈, R₉, R₁₀, R₁₁, R₁₂, R₁₃, R₁₄, R₁₅, R₁₆, R₁₇, and R₁₈ are independently selected from H and C1 to C3 alkyls, although complexes with arenes comprising one longer and more complex substituents also comprising heteroatoms as defined herein (for example, —(CH₂)ₙ—O—C(O)—C₆H₄-p-O—(CH₂)ₘCH₃) were also found to be highly active.

According to an embodiment, one substituent of R₇, R₈, R₉, R₁₀, R₁₁, and R₁₂, and/or, independently, one substituent of R₁₃, R₁₄, R₁₅, R₁₆, R₁₇, and R₁₈ is selected, from C4-C20 hydrocarbons optionally comprising 0-15 heteroatoms, with the proviso that said C4-C20 hydrocarbon optionally comprising 0-15 heteroatoms comprises at least one aromatic ring or ring system and/or comprises a radical or substituent derived from at least one bioactive compound, the entire substituents thus forming or containing a bioactive moiety, possibly linked by way of suitable linker. The other substituents are selected independently according to the preferred embodiments mentioned above, preferably from H and C1-C4 alkyls.

Preferred arenes, from which A₁ and A₂ may be independently selected are C₆H₆(benzene), C₆H₅Me (methylbenzene), C₆Me₆ (hexamethylbenzene), p-ⁱPrC₆H₄Me (p-cymene), C₉H₁₀ (indane), C₆H₆—(CH₂)ₙ—O—C(O)—C₆H₄-p-O—(CH₂)ₘCH₃, C₆H₆—(CH₂)ₙ—O—C(O)—CH═CH—C₆H₄-p-O—CH₃, with m being an integer of 1-6 and n being 1, 2, 3 or 4.

According to an embodiment, at least one of R₇, R₈, R₉, R₁₀, R₁₁, and R₁₂, is H. Preferably 2 to 6, more preferably 3 to 6 and most preferably 4 to 6 of R₇, R₈, R₉, R₁₀, R₁₁, and R₁₂, are H.

According to an embodiment, at least one of R₁₃, R₁₄, R₁₅, R₁₆, R₁₇, and R₁₈, is H. Preferably 2 to 6, more preferably 3 to 6 and most preferably 4 to 6 of R₁₃, R₁₄, R₁₅, R₁₆, R₁₇, and R₁₈ are H.

According to an embodiment, R₇, R₈, R₉, R₁₀, R₁₁, and R₁₂, are not all selected from alkyls and/or, independently, wherein R₁₃, R₁₄, R₁₅, R₁₆, R₁₇, and R₁₈, are not all selected from alkyls. According to an embodiment, R₇, R₈, R₉, R₁₀, R₁₁, and R₁₂, are not all methyl, and/or wherein, independently, R₁₃, R₁₄, R₁₅, R₁₆, R₁₇, and R₁₈, are not all methyl. In other words, at least one, but possibly both of A₁ and A₂ are different from peralkylated, in particular permethylated arene, in particular benzene. Preferably, one or both of A₁ and/or A₂ are different from hexamethylbenzene. These embodiments apply in particular to the complexes of the invention for use in methods of treatment. Preferably, these embodiments apply in particular to cationic complexes comprising the M₂X₃ core for use in therapy.

According to an embodiment, at least one of R₇, R₈, R₉, R₁₀, R₁₁, and R₁₂, is H and at least one is alkyl; and/or wherein, independently, at least one of R₁₃, R₁₄, R₁₅, R₁₆, R₁₇, and R₁₈, is H and at least one is alkyl.

According to an embodiment, at least one of R₇, R₈, R₉, R₁₀, R₁₁, and R₁₂ is a C2-C4, preferably a C3-C4 alkyl, for example a C3 alkyl and/or, independently, at least one of R₁₃, R₁₄, R₁₅, R₁₆, R₁₇, and R₁₈, is a C2-C4, preferably a C3-C4 alkyl, for example a C3 alkyl.

According to an embodiment, R₇, R₈, R₉, R₁₀, R₁₁, and R₁₂, are all H, or one is isopropyl and one is methyl, the other substituents being H; and/or wherein, independently, R₁₃, R₁₄, R₁₅, R₁₆, R₁₇, and R₁₈, are independently selected such that are all H, or one is isopropyl and one is methyl.

According to an embodiment, the present invention provides a complex of, or comprising, a structure selected from formula (IIa) and (IIb) below:

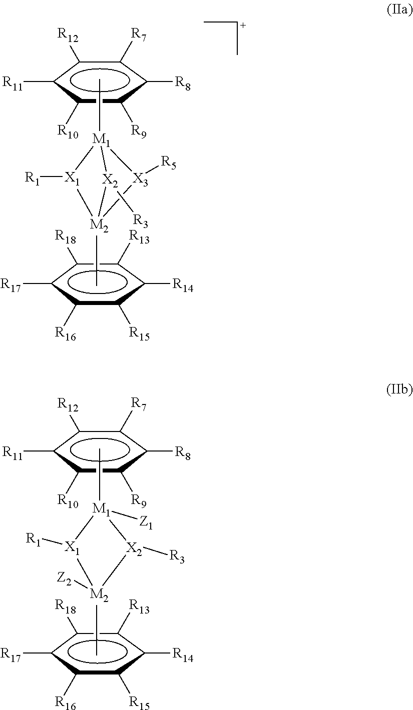

wherein M₁, M₂, R₁, R₃ and R₅, are, independently, as defined elsewhere in this specification, in particular above and below, for example such as defined with respect to any one of (Ia), (Ib), (IIa), (IIb), (IIIa), (IIIb), (IIIc), (IIId), (IVa), (IVb), and (IVc) in as far as applicable;
wherein X₁, X₂ and X₃ are selected from S, Se and O;
wherein Z₁ and Z₂ are as defined above, preferably halogen;
wherein substituents R₇, R₈, R₉, R₁₀, R₁₁, R₁₂, R₁₃, R₁₄, R₁₅, R₁₆, R₁₇, and R₁₈ are selected, independently, from: C4-C20 hydrocarbons optionally comprising 0-15 heteroatoms, with the proviso that said C4-C20 hydrocarbon optionally comprising 0-15 heteroatoms comprises at least one aromatic ring or ring system and/or comprises at least one bioactive moiety, and further from: H, halogens, hydroxyl, carboxylic acid group, nitro and amino, C1-C10 alkyls, C2-C10 alkenyls, C2-C10 alkynyls, C4-C10 aryl, C1-C10 alkoxyl, C2-C10 alkenoxyl, C₂-C₁₀ alkynoxyl, C4-C10 aryloxyl, wherein said alkyl, alkoxyl, alkenyl, alkenoxyl, alkynyl, alkynoxyl, may be totally or partially halogenated and/or may be linear or branched, wherein said aryl and/or an aryl moiety of said aryloxyl, if it is a C4 or a C5 aryl and/or aryloxyl, respectively, it comprises at least on heteroatom, wherein said aryl and aryloxyl may be further substituted, besides with halogen, with C1-C4 alkyl, and wherein substituents on neighbouring carbons of the benzene ring may be linked so as to form one or more rings fused to said benzene ring. Of course, this fused ring may be further substituents, as far as the other requirements on the respective substituents that are fused are met. Preferred embodiments and examples of M₁, M₂, R₁, R₃, R₅, X₁, X₂, X₃, R₇, R₈, R₉, R₁₀, R₁₁, R₁₂, R₁₃, R₁₄, R₁₅, R₁₆, R₁₇, and R₁₈ as appearing in formulae (IIa) and (IIb) are, independently, as detailed, exemplified and defined elsewhere in this specification, in particular herein above and herein below, with respect to any complex of formulae (Ia), (Ib), (lia), (IIIb), (IIIc), (IIId), (IVa), and (IVb), and other structures, partial structures and substituents disclosed herein.

According to an embodiment, the present invention provides a complex of or comprising a structure selected from formula (IIIa) and (IIIb):

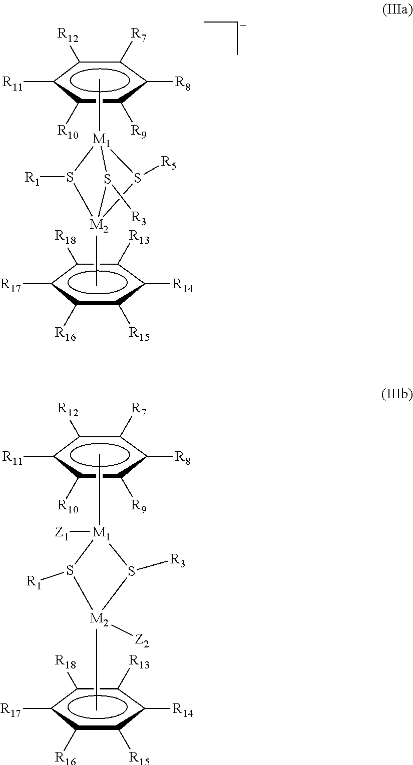

wherein:

M₁, M₂, R₁, R₃, R₅, R₇, R₈, R₉, R₁₀, R₁₁, R₁₂, R₁₃, R₁₄, R₁₅, R₁₆, R₁₇, R₁₈, Z₁ and Z₂ are independently as detailed, exemplified and defined elsewhere in this specification, in particular herein above and herein below, with respect to any complex of formula (Ia), (Ib), (IIa), (IIb), (IIIc), (IIId), (IVa), (IVb), and (IVc), in as far as applicable, and other structures, partial structures and substituents disclosed herein.

According to an embodiment, the present invention provides a complex of or comprising a structure selected from formulae (IIIc) and (IIId)

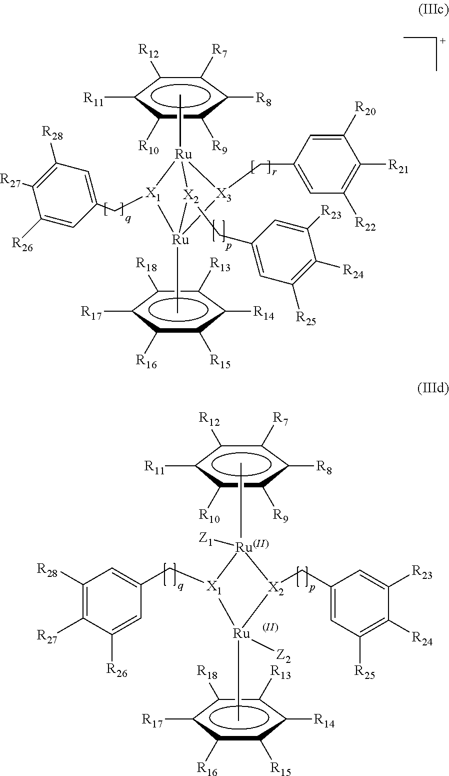

wherein X₁, X₂, X₃, in as far as present, are selected from S and Se;

R₇-R₈ and R₂₀-R₂₈, in as far as present, are independently selected as indicated elsewhere in this specification, in particular as indicated below;

said Ru atoms are in the Ru(II)-oxidation state;
r, p, q are independently selected from 0 and from the integers of 1-5, preferably from 0, 1, 2 and 3, most preferably from 0 and 1.

According to an embodiment, the present invention provides a complex of or comprising a structure selected from formula (IVa) and (IVb):

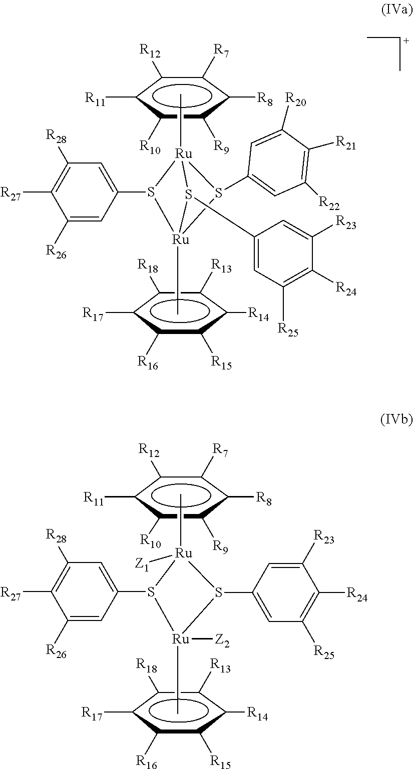

wherein:

R₇, R₈, R₉, R₁₀, R₁₁, R₁₂, R₁₃, R₁₄, R₁₅, R₁₆, R₁₇, and R₁₈ are independently as detailed, exemplified and defined elsewhere in this specification, in particular herein above and herein below, with respect to any complex of formula (Ia), (Ib), (IIa), (IIb), (IIIa), (IIIb), (IIIc), (IIId), and (IVc) and other structures, partial structures and substituents disclosed herein, in as far as applicable. R₂₀, R₂₁, R₂₂ R₂₃, R₂₄, R₂₅, R₂₆, R₂₇, R₂₈, in as far as present, may independently be selected from H, halogen, —R₃₀, —O—R₃₀, —O—R₃₅, wherein —R₃₀ and —O—R₃₅ are defined as disclosed elsewhere in this specification. According to an embodiment, —R₃₀ is independently selected from H and C1-C4 alkyl.

According to an embodiment, the present invention provides a complex of, or comprising, a structure of formula (IVc) below:

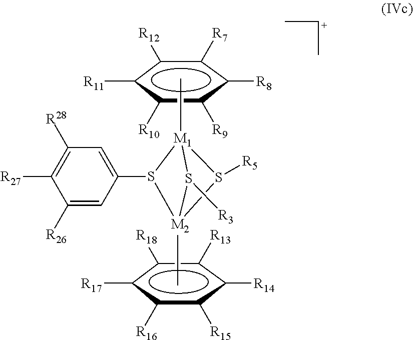

in which any one of M₁, M₂, (preferably Ru), R₃, R₅, R₇, R₈, R₉, R₁₀, R₁₁, R₁₂, R₁₃, R₁₄, R₁₅, R₁₆, R₁₇, R₁₈, R₂₃, R₂₄, R₂₅, R₂₆, R₂₇, R₂₈ are, independently, as defined elsewhere in this specification, in particular with respect to the structures of formula (Ia), (Ib), (IIa), (IIb), (IIIa), (IIIb), IIIc), (IIId), (IVa), and (IVb), in as far as applicable. For example, R₅ and R₃, in as far as present, is selected from H; substituted or unsubstituted aliphatic substituents; and from substituents derived independently from a natural compound and/or a bioactive compound, as disclosed hereinabove, for example with respect to R₁, R₃, and/or R₅ of formulae (Ia) and/or (Ib) above.

According to an embodiment, one, or two, or all three groups of substituents located on a specific benzenethiolate ligand (e.g. S-phenyl in formula (IIIc), (IIId) (if any one of p, q and r is 0), (IVa), (IVb), or (IVc) (group 1: R₂₀, R₂₁, R₂₂; group 2: R₂₃, R₂₄, R₂₅; group 3: R₂₆, R₂₇, R₂₈) are selected independently as defined elsewhere in this specification, for example above or below, with the proviso that they are free of any heteroatom, and/or that definitions of substituents that do not contain any heteroatom are encompassed, independently from the other substituents.

According to an embodiment, one, or two, or all three groups of substituents located on a specific benzenethiolato ligand (phenyl) (group 1: R₂₀, R₂₁, R₂₂; group 2: R₂₃, R₂₄, R₂₅; group 3: R₂₆, R₂₇, R₂₈), in as far as present, are selected independently from H and hydrophobic substituents.

According to an embodiment of the complex of formula (IV), (IVa), (IVb), and (IVc), R₂₀, R₂₁, R₂₂, R₂₃, R₂₄, R₂₅, R₂₆, R₂₇, R₂₈, in as far as present, are selected, independently, from H, C1-C4 alkyl, wherein said alkyl, if it has 3 or 4 carbons, may be branched. Even more preferably, R₂₀, R₂₁, R₂₂, R₂₃, R₂₄, R₂₅, R₂₆, R₂₇, R₂₈, in as far as present, are selected, independently, from H and methyl.

According to a preferred embodiment, the complex of the present invention is cationic, preferably carrying one positive charge, as exemplified by the structures of formulae (Ia), (IIa), (IIIa), (IVa) and (IVc).

According to an embodiment, the complex of the present invention has the formula [(arene)₂Ru₂(SR)₃]⁺ or [(arene)₂Ru₂(SR)₂Z₂], wherein arene is selected from C₆H₆(benzene), C₆H₅Me (methylbenzene), C₆Me₆ (hexamethylbenzene), p-ⁱPrC₆H₄Me (p-cymene), C₉H₁₀ (indane),

C₆H₆—(CH₂)ₙ—O—C(O)—C₆H₄-p-O—(CH₂)ₘCH₃, C₆H₆—(CH₂)ₙ—O—C(O)—CH═CH—C₆H₄-p-O—CH₃, with m being an integer of 1-6 and n being 1, 2, 3 or 4; and, R is selected from phenyl and C1-C3 alkylphenyl, in particular p-C1-C3 alkylphenyl.

According to an embodiment, the complex of the present invention is or comprises at least one binuclear ruthenium complex selected from the group of: [(C₆H₆)₂Ru₂(SPh)₃]⁺, [(C₆H₆)₂Ru₂(S-p-C₆H₄Me)₃]⁺, [(C₆H₅Me)₂Ru₂(S—Ph)₃]⁺, [(C₆H₅Me)₂Ru₂(S-p-C₆H₄Me)₃]⁺, [(C₆Me₆)₂Ru₂(SPh)₃]⁺, [(C₆Me₆)₂Ru₂(S-p-C₆H₄Me)₃]⁺, [(p-ⁱPrC₆H₄Me)₂Ru₂(SPh)₃]⁺, [(p-PrC₆H₄Me)₂Ru₂(S-p-C₆H₄Me)₃]⁺, [(C₆H₆—(CH₂)₂—O—C(O)—C₆H₄-p-O—(CH₂)₆CH₃)₂Ru₂(SPh)₃]⁺, [(C₆H₆—(CH₂)₂—O—C(O)—C₆H₄-p-O—(CH₂)₆CH₃)₂Ru₂(S-p-C₆H₄Me)₃]⁺, [(C₆H₆—(CH₂)₄—O—C(O)—C₆H₄-p-O—(CH₂)₆CH₃)₂Ru₂(SPh)₃]⁺, [(C₆H₆—(CH₂)₄—O—C(O)—C₆H₄-p-O—(CH₂)₆CH₃)₂Ru₂(S-p-C₆H₄Me)₃]⁺, [trans-(C₆H₆—(CH₂)₂—O—C(O)—CH═CH—C₆H₄-p-O—CH₃)₂Ru₂(SPh)₃]⁺, [trans-(C₆H₆—(CH₂)₂—O—C(O)—CH═CH—C₆H₄-p-O—CH₃)₂Ru₂(S-p-C₆H₄Me)₃]⁺, [trans-(C₆H₆—(CH₂)₄—O—C(O)—CH═CH—C₆H₄-p-O—CH₃)₂Ru₂(SPh)₃]⁺, [trans-(C₆H₆—(CH₂)₄—O—C(O)—CH═CH—C₆H₄-p-O—CH₃)₂Ru₂(S-p-C₆H₄Me)₃]⁺, [(C₆H₆)₂Ru₂(SPh)₂Z₂], [(C₆H₆)₂Ru₂(S-p-C₆H₄Me)₂Z₂], [(C₆H₅Me)₂Ru₂(S—Ph)₂Z₂], [(C₆H₅Me)₂Ru₂(S-p-C₆H₄Me)₂Z₂], [(C₆Me₆)₂Ru₂(SPh)₂Z₂], [(C₆Me₆)₂Ru₂(S-p-C₆H₄Me)₂Z₂], [(p-ⁱPrC₆H₄Me)₂Ru₂(SPh)₂Z₂], and [(p-ⁱPrC₆H₄Me)₂Ru₂(S-p-C₆H₄Me)₂ Z₂], wherein Z is halogen, preferably Cl. It is noted that Z₂ refers to the fact that there are two atoms Z present in the complex. Z₂ does not refer to the substituent Z₂ referred to in formulae (Ib), (IIb)

According to an embodiment, the complex of the invention, if it is cationic (formulae Ia, IIa, IIIa, IIIc, IVa, and IVc), is provided together with a pharmaceutically acceptable anionic species. The anionic species may be a pharmaceutically acceptable anion. According to a preferred embodiment, the anion is chloride.

Alternatively, the cationic complex of the invention may be provided together with a structure of higher molecular weight, carrying a plurality of negative charges, with several cationic complexes of the invention being associated with the supramolecular structure. For example, the cationic complex may be provided with one or more polyanions, for example anionic polyelectrolytes, for example artificial or natural polymers comprising a plurality of negative charges, such as anionic polypeptides, polysaccharides and the like, for example.

The invention also encompasses nanoparticles comprising any one of the complexes of the invention, in particular magnetic and/or ferromagnetic nanoparticles with modified surfaces so as to carry negative charges at the surface. Such nanoparticles may be helpful in targeting the complexes of the invention to specific cells.

The complexes of the invention exhibit high cytotoxicity against cancer cells. The complexes may thus be used as medicaments, in particular for the treatment of hyperproliferative disorders, in particular cancer.

According to an embodiment, the complexes of the invention are used in the treatment of any one or more selected independently from the group of a carcinoma, including a carcinoma of the bladder, breast, colon (e.g. colorectal carcinomas such as colon adenocarcinoma and colon adenoma), kidney, epidermal, liver, lung, for example adenocarcinoma, small cell lung cancer and non-small cell lung carcinomas, oesophagus, gall bladder, ovary, pancreas, including exocrine pancreatic carcinoma, stomach, cervix, thyroid, prostate, or skin, for example squamous cell carcinoma; a hematopoietic tumour of lymphoid lineage, for example leukaemia, acute lymphocytic leukaemia, B-cell lymphoma, T-cell lymphoma, Hodgkin's lymphoma, non-Hodgkin's lymphoma, hairy cell lymphoma, or Burkett's lymphoma; a hematopoietic tumour of myeloid lineage, for example acute or chronic myelogenous leukemias, myelodysplastic syndrome, or promyelocytic leukaemia; thyroid follicular cancer; a tumour of mesenchymal origin, for example fibrosarcoma or habdomyosarcoma; a tumour of the central or peripheral nervous system. for example astrocytoma, neuroblastoma, glioma or schannoma; melanoma; seminoma; teratocarcinoma; osteosarcoma; xenoderoma pigmentoum; keratoctanthoma; thyroid follicular cancer; or Kaposi's sarcoma.

According to a preferred embodiment, the complexes of the invention are used in the treatment of a carcinoma and/or sarcoma.

According to a preferred embodiment, the complexes of the invention are used in the treatment of a carcinoma squamous epithelium.

According to an embodiment, the complexes of the invention are used in the treatment of cancer, in particular carcinomas and/or sarcomas that are resistant to cisplatin.

According to a preferred embodiment, the complexes of the invention are used in the treatment of one or more selected from the group of small cell lung cancer, ovarian cancer), lymphomas, and germ cell tumors.

According to an embodiment, the complexes of the invention are used in the treatment of one or more carcinoma selected from the group of carcinoma of the testes, ovaries, bronchi, bladder, esophagus, oral cavity, skin and cervix, in particular squamous epithelium carcinoma of the former.

As mentioned above, the present invention also encompasses a method of treatment, such as a condition and/or a disease. The condition is preferably a proliferative disorder, such as cancer. The method comprises preferably the step of administering, to an individual and/or patient in need thereof, an effective amount of one or more compounds according to the invention.

The invention provides complexes as defined and disclosed in this specification, or prodrugs or solvates thereof (“active compounds”), for use in a method of treatment of the human or animal body. A method of treatment may comprise administering to such an individual a therapeutically-effective amount of the complex of the present invention, preferably in the form of a pharmaceutical composition.

The term “treatment” or “treating” is used herein in the context of treating a condition, and pertains generally to treatment and therapy, whether of a human or animal (e.g. in veterinary applications), in which some therapeutic effect is achieved, for example, the inhibition of the progress of the condition, and includes a reduction in the rate of the progress, a halt in the rate of the progress, amelioration of the condition, and cure of the condition. The condition usually is associated with suffering, from psychological and/or physical pain, with the individual being in need of a treatment. Treatment as a prophylactic measure (i.e. prophylaxis) is also included.

The complex of the invention or pharmaceutical composition comprising the active complex may be administered to an individual by any convenient route of administration, whether systemically/peripherically or at the site of desired action, including but not limited to, oral (e.g. by ingestion), topical (including e.g. transdermal, intranasal, ocular, buccal and sublingual), pulmonary (e.g. by inhalation or insufflation therapy using an aerosol, e.g. through mouth or nose), rectal, vaginal, parenteral, for example by injection, including subcutaneous, intradermal, intramuscular, intravenous, intraarterial, intracardiac, intrathecal, subcuticula, subcapsular, intraorbital, intraperitoneal, intratracheal, subarachnoid, and intrasternal, by implant of a depot (e.g. subcutaneously or intramuscularly).

The complex of the present invention may be administered alone, but is preferably presented as a pharmaceutical composition (e.g. formulation) comprising at least one active complex together with at least one or more pharmaceutically carriers, buffers, as mentioned in WO 2006/018649, p. 16-20, “formulations”, which reference is expressly incorporated herein by reference.

The present invention is described more concretely by way of the following examples, which, however, are not intended to be understood as any kind of restriction of the scope of the present invention.

### EXAMPLES

### General Comments

All reagents were purchased either from Aldrich or Fluka and used as received. The dimers [(arene)₂RuCl₂]₂ were prepared according to literature methods ((a) M. A. Bennett, T. N. Huang, T. W. Matheson, A. K. Smith, Inorg. Synth., 1982, 21, 74. (b) M. A. Bennett, T. W. Matheson, G. B. Robertson, A. K. Smith, P. A. Tucker, Inorg. Chem., 1980, 19, 1014. (c) M. A. Bennett, A. K. Smith, Dalton Trans., 1974, 2, 233. (d) R. A. Zelonka, M. C. Baird, Can. J. Chem., 1972, 50, 3063). Reactions were carried out under nitrogen. NMR spectra were recorded on a Bruker AMX 400 spectrometer using the residual protonated solvent as internal standard. Micro-analyses were performed by the Laboratory of Pharmaceutical Chemistry, University of Geneva (Switzerland) or by Mikroelementaranalytisches Laboratorium, ETH Ziurich (Switzerland). Electrospray ionisation mass spectra were obtained in positive-ion mode with an LCQ Finnigan mass spectrometer or performed at the Department of Chemistry of the University of Fribourg (Switzerland).

### Example 1

### Synthesis and Characterisation of the Diene Precursors 1-4

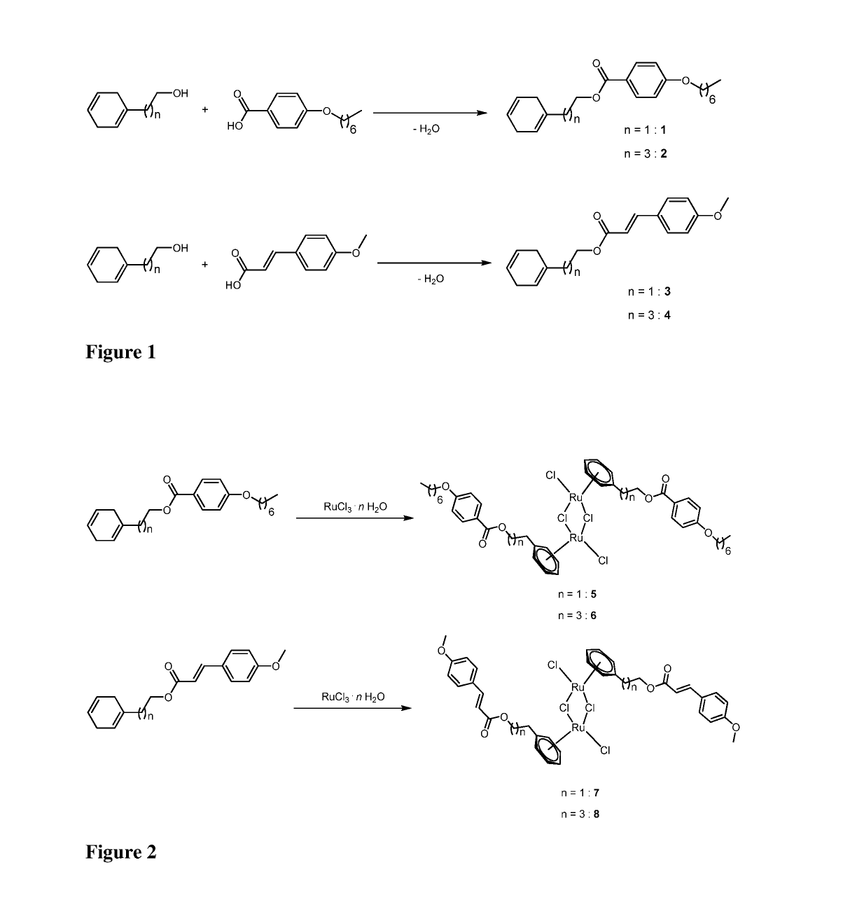

The compounds 2-(cyclohexa-1,4-dienyl)ethanol and 4-(cyclohexa-1,4-dienyl)butanol, accessible by Birch reduction of the corresponding benzene derivatives, (P. S. Engel, R. L. Allgren, W.-K. Chae, R. A. Leckonby, N. A. Marron, J. Org. Chem., 1979, 24, 4233 and F. K. Cheung, C. Lin, F. Minissi, A. L. Crivillé, M. A. Graham, D. J. Fox, M. Wills, Org. Lett., 2007, 22, 4659) react in the presence of 4-(dimethylamino)pyridine, N,N′-dicyclohexylcarbodiimide and 4-pyrrolidinopyridine as coupling reagents, with 4-(heptyloxy)benzoic acid to give the functionalised dienes 1 and 2, using conditions similar to those reported previously (W. H. Ang, L. J. Parker, A. De Luca, L. Juillerat-Jeanneret, C. J. Morton, M. Lo Bello, M. W. Parker, P. J. Dyson, Angew. Chem. Int. Ed., 2009, 48, 3854). The coupling with 4-methoxycinnamic acid under the same conditions yields to the functionalised dienes 3 and 4 (FIG. 1). The new compounds, obtained as colorless oils, were characterised by NMR spectroscopy, mass spectrometry and elemental analysis.

More specifically, to a Schlenk tube, the corresponding acid (5.2 mmol, 1.24 g for 1; 4.3 mmol, 1.01 g for 2; 5.2 mmol, 934 mg for 3; 4.3 mmol, 761 mg for 4), in the presence of the coupling reagents 4-(dimethylamino)pyridine (4 mmol, 492 mg for 1 and 3; 3.3 mmol, 401 mg for 2 and 4), N,N′-dicyclohexylcarbodiimide (8 mmol, 1.66 g for 1 and 3; 6.6 mmol, 1.36 g for 2 and 4) and 4-pyrrolidinopyridine (4 mmol, 597 mg for 1 and 3; 3.3 mmol, 497 mg for 2 and 4) were dissolved in CH₂Cl₂ (100 mL). After the addition of a solution of the diene (4 mmol, 500 mg for 1 and 3; 3.3 mmol, 500 mg for 2 and 4) in CH₂Cl₂ (10 mL), the reaction was stirred at 20° C. during 18 h. Then resulting mixture was filtered through celite and the solvent was removed under reduced pressure. The resulting oil was purified by column chromatography (silica gel, CH₂Cl₂/EtOH 4.8: 0.2); compounds 1-4 were isolated as colorless oils and dried in vacuo.

1. Colorless oil, yield: 1.15 g, 84%. ¹H NMR (400 MHz, CDCl₃): 0.91 (t, 3H, —CH₃), 1.44 (m, 8H, —CH₂—(CH₂)₄—CH₃), 1.80 (q, 2H, —O—CH₂—CH₂—(CH₂)₄—CH₃), 2.42 (t, 2H, C₆H₇—CH₂—CH₂—O—(CO)—Ar), 2.69 (s, 4H, CH₂diene), 3.99 (t, 2H, —O—CH₂—(CH₂)₅—CH₃), 4.38 (t, 2H, C₆H₇—CH₂—CH₂—O—(CO)—Ar), 5.55 (s, 1H, CHdiene), 5.71 (t, 2H, CHdiene), 6.89 (d, ³J=6.8 Hz, 2H, H—Ar), 7.98 ppm (d, ³J=6.8 Hz, 2H, H—Ar). ¹³C{¹H}NMR (100 MHz, CDCl₃): 14.18, 22.70, 26.05, 26.88, 29.13, 29.22, 29.26, 31.86, 35.42, 36.73, 60.66, 63.08, 65.23, 68.28, 114.09, 120.98, 124.17, 126.61, 131.64, 138.15, 163.07, 166.38 ppm. Mass (ESI, m/z): 365.18 [M+Na⁺]. Anal Calc. for (%): C₂₂H₃₀O₃: C, 77.16; H, 8.83. Found: C, 77.25; H, 8.69.

2. Colorless oil, yield: 1.16 g, 95%. ¹H NMR (400 MHz, CDCl₃): 0.91 (t, 3H, —CH₃), 1.33 (m, 10H, —CH₂—(CH₂)₄—CH₃, C₆H₇—CH₂—CH₂—CH₂—CH₂—O—(CO)—Ar), 1.79 (m, 4H, C₆H₇—CH₂—CH₂—CH₂—CH₂—O—(CO)—Ar, —O—CH₂—CH₂—(CH₂)₄—CH₃), 2.05 (t, 2H, C₆H₇—CH₂—(CH₂)₃—O—(CO)—Ar), 2.62 (m, 2H, CH₂diene), 2.70 (m, 2H, CH₂diene), 4.01 (t, 2H, —O—CH₂—(CH₂)₅—CH₃), 4.31 (t, 2H, C₆H₇—(CH₂)₃—CH₂—O—(CO)—Ar), 5.46 (s, 1H, CHdiene), 5.72 (t, 2H, CHdiene), 6.91 (d, ³J=6.8 Hz, 2H, H—Ar), 8.00 ppm (d, ³J=6.8 Hz, 2H, H—Ar). ¹³C{¹H} NMR (100 MHz, CDCl₃): 14.10, 22.62, 25.26, 25.98, 26.78, 27.87, 28.46, 28.88, 29.06, 29.15, 31.79, 37.05, 64.61, 68.21, 114.05, 118.73, 124.30, 124.32, 125.84, 128.36, 131.53, 134.53, 162.93, 166.48 ppm. Mass (ESI, m/z): 393.10 [M+Na⁺]. Anal Calc. for (%): C₂₄H₃₄O₃: C, 77.80; H, 9.25. Found: C, 77.91; H, 9.39.

3. Colorless oil, yield: 1.02 g, 89%. ¹H NMR (400 MHz, CDCl₃): 2.37 (t, 2H, C₆H₇—CH₂—CH₂—O—(CO)—CH═CH—), 2.69 (m, 4H, CH₂diene), 3.82 (s, 3H, —O—CH₃), 4.29 (t, 2H, C₆H₇—CH₂—CH₂—O—(CO)—CH═CH—), 5.53 (s, 1H, CHdiene), 5.71 (t, 2H, CHdiene), 6.30 (d, ³J=16 Hz, 1H, —CH═CH—), 6.91 (d, 2H, H—Ar), 7.47 (d, 2H, H—Ar), 7.64 ppm (d, ³J=16 Hz, 1H, —CH═CH—). ¹³C{¹H}NMR (100 MHz, CDCl₃): 26.85, 36.64, 55.42, 62.78, 64.93, 114.38, 115.83, 120.88, 124.21, 126.61, 129.11, 129.76, 129.81, 144.43, 161.44, 161.48, 167.27, 167.34 ppm. Mass (ESI, m/z): 307.20 [M+Na⁺]. Anal Calc. for (%): C₁₈H₂₀O₃: C, 77.03; H, 7.09. Found: C, 77.26; H, 7.15.

4. Colorless oil, yield: 870 mg, 84%. ¹H NMR (400 MHz, CDCl₃): 1.54 (m, 2H, C₆H₇—CH₂—CH₂—(CH₂)₂—O—(CO)—CH═CH—), 1.71 (m, 2H, C₆H₇—(CH₂)₂—CH₂—CH₂—O—(CO)—CH═CH—), 2.03 (t, 2H, C₆H₇—CH₂—(CH₂)₃—O—(CO)—CH═CH—), 2.61 (m, 2H, CH₂diene), 2.69 (m, 2H, CH₂diene), 3.84 (s, 3H, —O—CH₃), 4.21 (t, 2H, C₆H₇—(CH₂)₃—CH₂—O—(CO)—CH═CH—), 5.45 (m, 1H, CHdiene), 5.72 (m, 2H, CHdiene), 6.32 (d, ³J=16 Hz, 1H, —CH═CH—), 6.91 (d, 2H, H—Ar), 7.49 (d, 2H, H—Ar), 7.65 ppm (d, ³J=16 Hz, 1H, —CH═CH—). ¹³C{¹H}NMR (100 MHz, CDCl₃): 23.68, 26.78, 28.22, 28.88, 37.04, 53.45, 55.37, 64.39, 114.33, 115.75, 118.71, 124.32, 125.84, 127.23, 128.43, 129.71, 134.54, 144.27, 161.37, 167.42 ppm. Mass (ESI, m/z): 335.07 [M+Na⁺]. Anal Calc. for (%): C₂₀H₂₄O₃: C, 76.89; H, 7.74. Found: C, 76.95; H, 7.62.

### Example 2

### Preparation of the Arene Ruthenium Chloro Intermediates 5-8

The complexes [(C₆H₅R)RuCl₂]₂ (where R═(CH₂)₂—O—C(O)—C₆H₄-p-O(CH₂)₆CH₃: 5, (CH₂)₄—O—C(O)—C₆H₄-p-O(CH₂)₆CH₃: 6, (CH₂)₂—O—C(O)—CH═CH—C₆H₄-p-OCH₃: 7, (CH₂)₄—O—C(O)—CH═CH—C₆H₄-p-OCH₃: 8), are accessible from the reaction of the corresponding dienes 1, 2, 3 and 4 with ruthenium(III) chloride hydrate in refluxing acetone/water (5:1), see the scheme in FIG. 2. Complexes 5-8 are air-stable brown to orange crystalline solids, which are soluble in dichloromethane and chloroform.

Specifically, To a solution of RuCl₃.nH₂O (0.8 mmol, 209 mg for 5 and 7; 0.6 mmol, 155 mg for 6 and 8) in degassed acetone/water 5:1 (100 mL) a solution of the corresponding diene (4 mmol, 1.37 g for 5, 1.14 g for 7; 3 mmol, 1.10 g for 6, 937 mg for 8) in degassed acetone/water 5:1 (10 mL) was added and the mixture was refluxed for 18 h. The solvent was removed under reduced pressure, and the residue was dissolved in dichloromethane (5 mL). Then the product was precipitated by addition of diethyl ether (50 mL), isolated by filtration and dried in vacuo.

5. Orange solid, yield: 380 mg, 93%. ¹H NMR (400 MHz, CDCl₃): 0.83 (t, 6H, —CH₃), 1.37 (m, 16H, —CH₂—(CH₂)₄—CH₃), 1.79 (q, 4H, —O—CH₂—CH₂—(CH₂)₄—CH₃), 3.04 (t, 4H, C₆H₅—CH₂—CH₂—O—(CO)—Ar), 3.98 (t, 4H, —O—CH₂—(CH₂)₅—CH₃), 4.54 (t, 4H, C₆H₅—CH₂—CH₂—O—(CO)—Ar), 5.50 (d, 4H, CHₐᵣₑₙₑ), 5.66 (m, 6H, CHₐᵣₑₙₑ), 6.86 (d, ³J=6.8 Hz, 4H, H—Ar), 7.86 ppm (d, ³J=6.8 Hz, 4H, H—Ar). ¹³C{¹H}NMR (100 MHz, CDCl₃): 14.19, 22.46, 22.72, 26.06, 29.13, 29.21, 31.87, 33.70, 34.25, 62.91, 68.40, 80.48, 81.37, 84.22, 97.68, 114.35, 121.73, 131.67, 163.38, 165.95 ppm. Mass (ESI, m/z): 977.20 [M-2Cl⁻+Na⁺]. Anal Calc. for (%): C₄₄H₅₆Cl₄O₃Ru₂: C, 51.56; H, 5.51. Found: C, 51.50; H, 5.34.

6. Orange solid, yield: 290 mg, 90%. ¹H NMR (400 MHz, CDCl₃): 0.87 (t, 6H, —CH₃), 1.37 (m, 16H, —CH₂—(CH₂)₄—CH₃), 1.75 (m, 12H, C₆H₅—CH₂—CH₂—CH₂—CH₂—O—(CO)—Ar, —O—CH₂—CH₂—(CH₂)₄—CH₃), 2.60 (t, 4H, C₆H₅—CH₂—(CH₂)₃—O—(CO)—Ar), 3.97 (t, 4H, —O—CH₂—(CH₂)₅—CH₃), 4.26 (t, 4H, C₆H₅—(CH₂)₃—CH₂—O—(CO)—Ar), 5.38 (d, 4H, CHₐᵣₑₙₑ), 5.60 (m, 6H, CHrₐᵣₑₙₑ), 6.87 (d, ³J=8.8 Hz, 4H, H—Ar), 7.92 ppm (d, ³J=8.8 Hz, 4H, H—Ar). ¹³C{¹H}NMR (100 MHz, CDCl₃): 14.15, 22.65, 26.00, 26.35, 28.56, 29.08, 29.17, 31.81, 33.25, 64.00, 68.29, 79.86, 80.46, 84.22, 100.99, 114.16, 122.38, 131.62, 163.06, 166.37 ppm. Mass (ESI, m/z): 1033.20 [M-2Cl⁻+Na⁺]. Anal Calc. for (%): C₄₈H₆₄Cl₄O₆Ru₂: C, 53.33; H, 5.97. Found: C, 53.51; H, 5.94.

7. Brown solid, yield: 216 mg, 72%. ¹H NMR (400 MHz, CDCl₃): 2.85 (t, 4H, C₆H₅—CH₂—CH₂—O—(CO)—CH═CH—), 3.67 (s, 6H, —O—CH₃), 4.35 (t, 4H, C₆H₅—CH₂—CH₂—O—(CO)—CH═CH), 5.59 (d, 4H, CHₐᵣₑₙₑ), 5.77 (m, 6H, CHₐᵣₑₙₑ), 6.10 (d, ³J=16 Hz, 2H, —CH═CH—), 6.74 (d, 4H, H—Ar), 7.31 (d, 4H, H—Ar), 7.44 ppm (d, ³J=16 Hz, 2H, —CH═CH—). 13C{¹H}NMR (100 MHz, CDCl₃): 35.60, 55.12, 62.10, 84.34, 86.65, 88.48, 103.57, 114.10, 114.33, 126.45, 129.43, 144.93, 157.74, 161.30, 166.42, 172.13 ppm. Mass (ESI, m/z): 861.13 [M-2Cl⁻+Na⁺]. Anal Calc. for (%): C₃₆H₃₆Cl₄O₂Ru₂: C, 47.59; H, 3.99. Found: C, 47.71; H, 4.06.

8. Brown solid, yield: 252 mg, 82%. ¹H NMR (400 MHz, CDCl₃): 1.73 (m, 8H, C₆H₅—CH₂—CH₂—CH₂—CH₂—O—(CO)—CH═CH—), 2.61 (t, 4H, C₆H₅—CH₂—(CH₂)₃—O—(CO)—CH═CH), 3.83 (s, 6H, —O—CH₃), 4.19 (t, 4H, C₆H₅—(CH₂)₃—CH₂—O—(CO)—CH═CH—), 5.39 (d, 4H, CHₐᵣₑₙₑ), 5.60 (m, 6H, CHₐᵣₑₙₑ), 6.28 (d, ³J=16 Hz, 2H, —CH═CH—), 6.90 (d, 4H, H—Ar), 7.48 (d, 4H, H—Ar), 7.62 ppm (d, ³J=16 Hz, 2H, —CH═CH—). ¹³C{¹H}NMR (100 MHz, CDCl₃): 26.41, 28.58, 33.31, 55.52, 63.85, 79.93, 80.56, 84.28, 101.08, 114.47, 115.58, 127.26, 129.91, 144.69, 161.56, 167.40 ppm. Mass (ESI, m/z): 917.07 [M-2Cl⁻+Na⁺]. Anal Calc. for (%): C₄₀H₄₄Cl₄O₂Ru₂: C, 49.80; H, 4.60. Found: C, 49.87; H, 4.66.

### Example 3

### Synthesis and Characterisation of the Functionalised Arene Ruthenium Thiophenolato Complexes 9-12

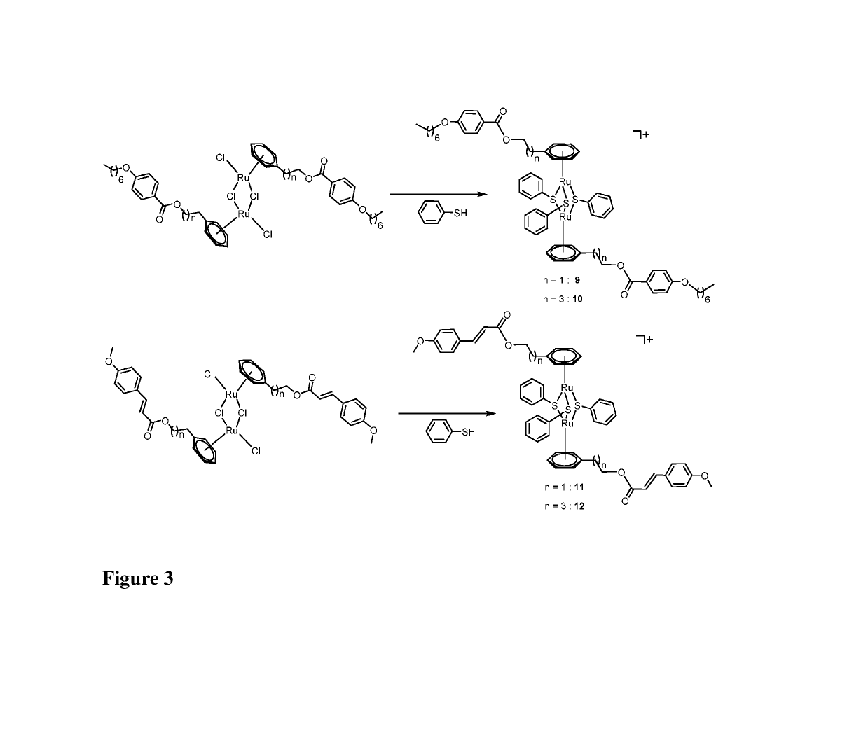

The arene ruthenium chloro intermediates 5-8 react with thiophenol in refluxing ethanol to give the dinuclear arene ruthenium thiophenolato complexes [(arene)₂Ru₂(SPh)₃]⁺, arene being C₆H₅R(R═(CH₂)₂—O—C(O)—C₆H₄-p-O(CH₂)₆CH₃: 9, (CH₂)₄—O—C(O)—C₆H₄-p-O(CH₂)₆CH₃: 10, (CH₂)₂—O—C(O)—CH═CH—C₆H₄-p-OCH₃: 11, (CH₂)₄—O—C(O)—CH═CH—C₆H₄-p-OCH₃: 12), according to the scheme shown in FIG. 3.

The chloride salts of 9-12 are obtained as air-stable orange to red crystalline solids which are soluble in methanol, dichloromethane and chloroform. The ¹H NMR spectra of the dinuclear arene ruthenium thiophenolato complexes [(arene)₂Ru₂(SPh)₃]⁺ 9-12 in CDCl₃ give rise to two signals for the three equivalent thiophenolato groups (9: 7.37 m, 7.88 d ppm; 10: 7.36 m, 7.92 d ppm; 11: 7.42 m, 7.88 d ppm; 12: 7.41 m, 7.85 d ppm), and to the characteristic arene ligand signals. The ESI mass spectra of 9-12 contain molecular ion peaks at m/z 1211, 1267, 1095 and 1151, respectively.

The dinuclear dichloro complex [(arene)₂RuCl₂]₂ (0.15 mmol, 150 mg for 9, 162 mg for 10, 136 mg for 11, 144 mg for 12) was refluxed in technical grade EtOH (50 mL). As soon as the starting material was completely dissolved, a solution of thiophenol (0.9 mmol, 99 mg, 92 μL) in technical grade EtOH (5 mL) was added dropwise to the hot solution. The resulting mixture was refluxed in EtOH for 18 h. After cooling to 20° C., the solvent was removed under reduced pressure. Tthe mixture was purified by column chromatography (silica gel, CH₂Cl₂/EtOH 5: 1), and the compounds [9-12]Cl were isolated as air-stable orange to red crystalline solids and dried in vacuo.

[9]Cl. Red solid, yield: 174 mg, 93%. ¹H NMR (400 MHz, CDCl₃): 0.88 (t, 6H, —CH₃), 1.30 (m, 16H, —CH₂—(CH₂)₄—CH₃), 1.78 (q, 4H, —O—CH₂—CH₂—(CH₂)₄—CH₃), 2.12 (m, 4H, C₆H₅—CH₂—CH₂—O—(CO)—Ar), 2.36 (m, 4H, C₆H₅—CH₂—CH₂—O—(CO)—Ar), 3.98 (t, 4H, —O—CH₂—(CH₂)₅—CH₃), 4.13 (m, 4H, C₆H₅—CH₂—CH₂—O—(CO)—Ar), 5.62 (m, 4H, C₆H₅—CH₂—CH₂—O—(CO)—Ar), 5.13 (d, 2H, CHₐᵣₑₙₑ), 5.38 (m, 4H, CHₐᵣₑₙₑ), 5.62 (m, 4H, CHₐᵣₑₙₑ), 6.86 (d, ³J=9.2 Hz, 4H, H—Ar), 7.37 (m, 9H, H—Ar), 7.78 (d, ³J=9.2 Hz, 4H, H—Ar), 7.88 ppm (d, 6H, H—Ar). ¹³C{¹H}NMR (100 MHz, CDCl₃): 14.20, 22.71, 26.05, 29.13, 29.20, 31.87, 32.18, 63.01, 68.45, 85.57, 86.03, 86.08, 86.35, 87.56, 99.80, 114.38, 121.58, 128.63, 129.59, 131.64, 132.23, 138.55, 163.42, 165.81 ppm. Mass (ESI, m/z): 1211.26 [M+H⁺]. Anal Calc. for (%): C₆₂H₇₁ClO₆Ru₂S₃: C, 59.76; H, 5.74. Found: C, 59.81; H, 5.80.

[10]Cl. Red solid, yield: 169 mg, 91%. ¹H NMR (400 MHz, CDCl₃): 0.88 (t, 6H, —CH₃), 1.30 (m, 16H, —CH₂—(CH₂)₄—CH₃), 1.55 (m, 12H, C₆H₅—CH₂—CH₂—CH₂—CH₂—O—(CO)—Ar, —O—CH₂—CH₂—(CH₂)₄—CH₃), 1.80 (t, 4H, C₆H₅—CH₂—(CH₂)₃—O—(CO)—Ar,), 3.99 (t, 4H, —O—CH₂—(CH₂)₅—CH₃), 4.11 (t, 4H, C₆H₅—(CH₂)₃—CH₂—O—(CO)—Ar), 4.97 (d, 2H, CHₐᵣₑₙₑ), 5.27 (m, 4H, CHₐᵣₑₙₑ), 5.59 (m, 4H, CHₐᵣₑₙₑ), 6.88 (d, ³J=8 Hz, 4H, H—Ar), 7.36 (m, 9H, H—Ar), 7.84 (d, ³J=8 Hz, 4H, H—Ar), 7.92 ppm (d, 6H, H—Ar). ¹³C{¹H}NMR (100 MHz, CDCl₃): 14.19, 22.71, 26.06, 26.20, 28.42, 29.14, 29.23, 31.87, 32.09, 63.76, 68.41, 85.40, 86.28, 86.34, 103.70, 114.24, 122.36, 128.48, 129.47, 131.66, 132.24, 138.87, 163.20, 166.44 ppm. Mass (ESI, m/z): 1267.32 [M+H⁺]. Anal Calc. for (%): C₆₆H₇₉ClO₆Ru₂S₃: C, 60.88; H, 6.12. Found: C, 60.81; H, 5.98.

[11]Cl. Orange solid, yield: 148 mg, 87%. ¹H NMR (400 MHz, CDCl₃): 2.76 (t, 4H, C₆H₅—CH₂—CH₂—O—(CO)—CH═CH—), 3.83 (s, 6H, —O—CH₃), 4.06 (t, 4H, C₆H₅—CH₂—CH₂—O—(CO)—CH═CH—), 5.12 (d, 2H, CHₐᵣₑₙₑ), 5.36 (m, 4H, CHₐᵣₑₙₑ), 5.61 (m, 4H, CHₑₑₙe), 6.14 (d, ³J=16 Hz, 2H, —CH═CH—), 6.89 (d, 4H, H—Ar), 7.42 (m, 13H, H—Ar), 7.53 (d, ³J=16 Hz, 2H, —CH═CH—), 7.88 ppm (d, 6H, H—Ar). ¹³C{(H}NMR (100 MHz, CDCl₃): 32.12, 55.57, 62.73, 85.53, 86.07, 86.13, 86.37, 87.56, 99.84, 114.54, 114.61, 126.88, 128.63, 129.61, 130.06, 132.26, 138.60, 145.47, 161.79, 166.79 ppm. Mass (ESI, m/z): 1095.09 [M+H⁺]. Anal Calc. for (%): C₅₄H₅₁ClO₆Ru₂S₃: C, 57.41; H, 4.55. Found: C, 57.52; H, 4.47.

[12]Cl. Orange solid, yield: 152 mg, 86%. ¹H NMR (400 MHz, CDCl₃): 1.83 (m, 8H, C₆H₅—CH₂—CH₂—CH₂—CH₂—O—(CO)—CH═CH—), 2.01 (m, 4H, C₆H₅—CH₂—(CH₂)₃—O—(CO)—CH═CH—), 3.82 (s, 6H, —O—CH₃), 4.02 (t, 4H, C₆H₅—(CH₂)₃—CH₂—O—(CO)—CH═CH—), 4.97 (d, 2H, CHₐᵣₑₙₑ), 5.26 (m, 4H, CHₐᵣₑₙₑ), 5.59 (m, 6H, CHₐᵣₑₙₑ), 6.25 (d, ³J=16 Hz, 2H, —CH═CH—), 6.89 (d, 4H, H—Ar), 7.41 (m, 13H, H—Ar), 7.60 (d, ³J=16 Hz, 2H, —CH═CH—), 7.85 ppm (d, 6H, H—Ar), ¹³C{(H}NMR (100 MHz, CDCl₃): 15.29, 26.05, 28.26, 31.97, 55.30, 55.45, 63.42, 65.86, 84.71, 85.28, 86.18, 86.21, 103.62, 113.91, 114.41, 115.32, 127.01, 128.39, 129.24, 129.27, 132.15, 138.78, 144.65, 161.53, 167.27 ppm. Mass (ESI, m/z): 1151.15 [M+H⁺]. Anal Calc. for (%): C₅₈H₅₉ClO₆Ru₂S₃: C, 58.74; H, 5.01. Found: C, 58.82; H, 4.85.

### Example 4

### Synthesis and Characterisation of the Functionalised Arene Ruthenium Hydroxy-Thiophenolato Complexes 13-16

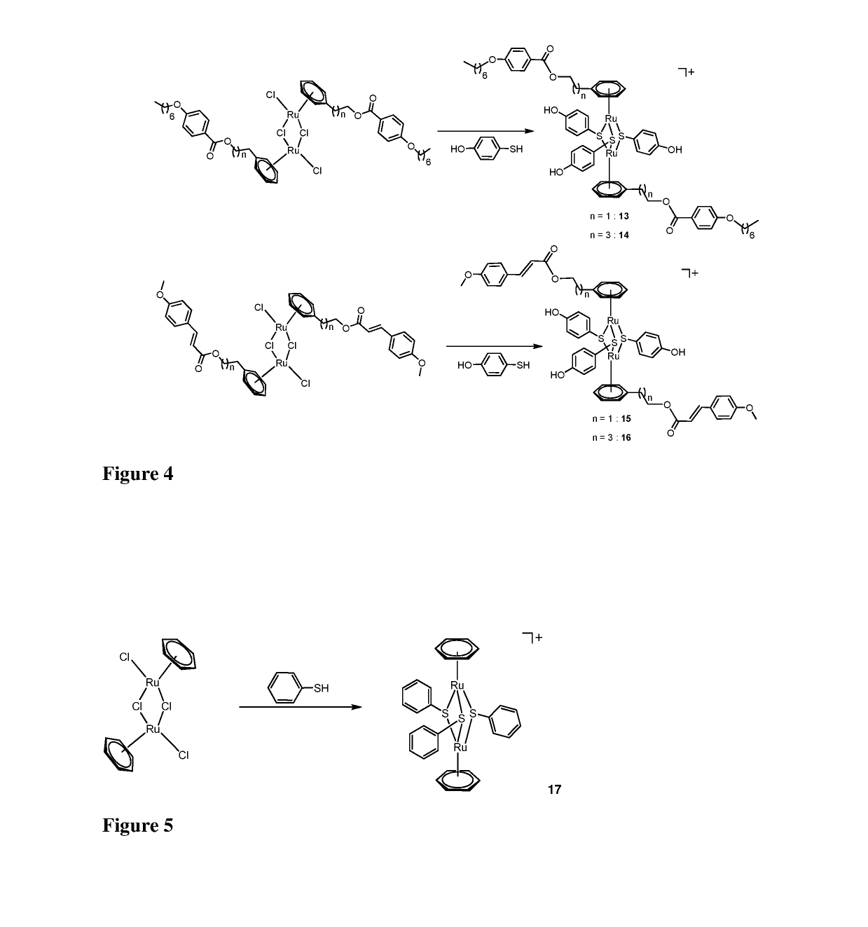

Since the anticancer activity of arene ruthenium complexes depends to some extent on their lipophilic and on their hydrophilic properties, the thiolato bridges in the [(arene)₂Ru₂(SPh)₃]⁺ complexes were modified by the introduction of a p-hydroxy function onto the phenyl substituent to increase water solubility. This was achieved by reacting the [(arene)RuCl₂]₂ intermediates 5-8 with p-hydroxythiophenol in a similar fashion to the method outlined above, to afford the dinuclear arene ruthenium complexes [(C₆HsR)₂Ru₂(S-p-C₆H₄—OH)₃]⁺ (where R═(CH₂)₂—O—C(O)—C₆H₄-p-O(CH₂)₆CH₃: 13, (CH₂)₄—O—C(O)—C₆H₄-p-O(CH₂)₆CH₃: 14, (CH₂)₂—O—C(O)—CH═CH—C₆H₄-p-OCH₃: 15, (CH₂)₄—O—C(O)—CH═CH—C₆H₄-p-OCH₃: 16), see the reaction scheme in FIG. 4.

The chloride salts of 13-16, which are soluble in dichloromethane, chloroform and in other polar organic solvents, are obtained as air-stable yellow to orange crystalline solids. The ¹H NMR spectra of 13-16 in CDCl₃ provide the two signals of the three equivalent hydroxythiophenolato groups (13: 7.01 d, 7.63 d ppm; 14: 6.93 d, 7.52 d ppm; 15: 6.90 d, 7.62 d ppm; 16: 6.82 d, 7.47 d ppm), and the characteristic arene ligand signals (see Experimental). In the ESI mass spectra, the molecular peaks of 13-16 are observed at m/z 1259, 1315, 1143 and 1199, respectively.

The dinuclear dichloro complex [(arene)₂RuCl₂]₂ (0.05 mmol, 50 mg for 13, 54 mg for 14, 45 mg for 15, 48 mg for 16) was refluxed in technical grade EtOH (50 mL). As soon as the starting material was completely dissolved, a solution of p-hydroxythiophenol (0.3 mmol, 38 mg) in technical grade EtOH (5 mL) was added dropwise to the hot solution. The resulting mixture was refluxed in EtOH for 18 h. After cooling to 20° C., the solvent was removed under reduced pressure. The mixture was purified by column chromatography (silica gel, CH₂Cl₂/EtOH 5: 1) and [13-16]Cl were isolated as air-stable yellow to orange crystalline solids and dried in vacuo.

[13]Cl. Orange solid, yield: 52 mg, 82%. ¹H NMR (400 MHz, CDCl₃): 0.83 (t, 6H, —CH₃), 1.35 (m, 16H, —CH₂—(CH₂)₄—CH₃), 1.71 (q, 4H, —O—CH₂—CH₂—(CH₂)₄—CH₃), 2.30 (m, 8H, C₆H₅—CH₂—CH₂—O—(CO)—Ar, C₆H₅—CH₂—CH₂—O—(CO)—Ar), 3.92 (t, 4H, —O—CH₂—(CH₂)₅—CH₃), 4.19 (m, 4H, C₆H₅—CH₂—CH₂—O—(CO)—Ar), 5.05 (d, 2H, CHₐᵣₑₙₑ), 5.17 (m, 2H, CHₐᵣₑₙₑ), 5.25 (m, 2H, CHₐᵣₑₙₑ), 5.38 (m, 4H, CHₐᵣₑₙₑ), 6.82 (d, 4H, H—Ar), 7.01 (d, 6H, H—Ar), 7.63 (d, 6H, H—Ar), 7.74 ppm (d, 4H, H—Ar). ¹³C{¹H}NMR (100 MHz, CDCl₃): 14.17, 22.67, 26.01, 29.17, 29.79, 31.82, 32.28, 63.47, 68.44, 84.60, 85.93, 85.97, 86.54, 100.01, 114.41, 116.95, 121.46, 127.46, 131.64, 133.25, 158.29, 163.40, 166.12 ppm. Mass (ESI, m/z): 1259.23 [M+H⁺]. Anal Calc. for (%): C₆₂H₇₁ClO₉Ru₂S₃: C, 57.55; H, 5.53. Found: C, 57.68; H, 5.59.

[14]Cl. Orange solid, yield: 60 mg, 89%. ¹H NMR (400 MHz, CDCl₃): 0.83 (t, 6H, —CH₃), 1.37 (m, 16H, —CH₂—(CH₂)₄—CH₃), 1.52 (m, 12H, C₆H₅—CH₂—CH₂—CH₂—CH₂—O—(CO)—Ar, —O—CH₂—CH₂—(CH₂)₄—CH₃), 1.95 (t, 4H, C₆H₅—CH₂—(CH₂)₃—O—(CO)—Ar,), 3.94 (t, 4H, —O—CH₂—(CH₂)₅—CH₃), 4.12 (t, 4H, C₆H₅—(CH₂)₃—CH₂—O—(CO)—Ar), 4.85 (d, 2H, CHₐᵣₑₙₑ), 5.04 (m, 4H, CHₐᵣₑₙₑ), 5.29 (m, 4H, CHₐᵣₑₙₑ), 6.83 (d, 4H, H—Ar), 6.93 (d, 6H, H—Ar), 7.52 (d, 6H, H—Ar), 7.87 ppm (d, 4H, H—Ar). ¹³C{¹H}NMR (100 MHz, CDCl₃): 14.09, 22.57, 25.92, 26.43, 28.30, 29.00, 29.08, 31.72, 32.13, 63.81, 68.25, 83.57, 84.70, 86.05, 86.10, 103.81, 114.09, 116.74, 122.19, 127.20, 131.55, 132.93, 158.53, 163.03, 166.36 ppm. Mass (ESI, m/z): 1315.30 [M+H⁺]. Anal Calc. for (%): C₆₆H₇₉ClO₉Ru₂S₃: C, 58.71; H, 5.90. Found: C, 58.83; H, 5.84.

[15]Cl. Yellow solid, yield: 49 mg, 83%. ¹H NMR (400 MHz, CDCl₃): 2.29 (m, 4H, C₆H₅—CH₂—CH₂—O—(CO)—CH═CH—), 3.79 (s, 6H, —O—CH₃), 4.09 (t, 4H, C₆H₅—CH₂—CH₂—O—(CO)—CH═CH—), 5.02 (d, 2H, CHₐᵣₑₙₑ), 5.21 (m, 4H, CHeₐᵣₑₙₑ), 5.40 (m, 4H, CHWₐᵣₑₙₑ), 6.13 (d, ³J=16 Hz, 2H, —CH═CH—), 6.90 (d, 6H, H—Ar), 7.42 (m, 8H, H—Ar), 7.48 (d, ³J=16 Hz, 2H, —CH═CH—), 7.62 ppm (d, 6H, H—Ar). ¹³C{¹H}NMR (100 MHz, CDCl₃): 32.13, 55.47, 63.03, 85.81, 85.95, 96.06, 86.46, 99.86, 114.46, 116.65, 126.77, 127.52, 129.25, 130.03, 133.23, 145.58, 158.11, 161.73, 167.13 ppm. Mass (ESI, m/z): 1143.09 [M+H⁺]. Anal Calc. for (%): C₅₄H₅₁ClO₉Ru₂S₃: C, 55.07; H, 4.36. Found: C, 55.16; H, 4.44.

[16]Cl. Yellow solid, yield: 54 mg, 88%. ¹H NMR (400 MHz, CDCl₃): 1.43 (m, 8H, C₆H₅—CH₂—CH₂—CH₂—CH₂—O—(CO)—CH═CH—), 1.89 (m, 4H, C₆H₅—CH₂—(CH₂)₃—O—(CO)—CH═CH—), 3.71 (s, 6H, —O—CH₃), 3.96 (t, 4H, C₆H₅—(CH₂)₃—CH₂—O—(CO)—CH═CH—), 4.78 (d, 2H, CHₐᵣₑₙₑ), 4.98 (m, 4H, CHₐᵣₑₙₑ), 5.24 (m, 6H, CHₐᵣₑₙₑ), 6.15 (d, ³J=16 Hz, 2H, —CH═CH—), 6.77 (d, 4H, H—Ar), 6.82 (d, 6H, H—Ar), 7.34 (d, 4H, H—Ar), 7.47 (d, 6H, H—Ar), 7.52 ppm (d, ³J=16 Hz, 2H, —CH═CH—). ¹³C{¹H}NMR (100 MHz, CDCl₃): 15.26, 26.12, 28.12, 31.92, 55.27, 63.32, 77.37, 83.40, 84.51, 84.84, 85.98, 114.23, 115.17, 116.44, 129.61, 132.84, 144.43, 158.32, 161.32, 167.03 ppm. Mass (ESI, m/z): 1199.14 [M+H⁺]. Anal Calc. for (%): C₅₈H₅₉ClO₉Ru₂S₃: C, 56.46; H, 4.82. Found: C, 56.51; H, 4.85.

### Example 5

### Synthesis and Characterisation of the Unfunctionalised Arene Ruthenium Thio-Phenolato Complexes 17-19

In order to study the influence of the lipophilic chains in the arene ligands on the biological activity, we also synthesised the unfunctionalised cation [(C₆H₆)₂Ru₂(SPh)₃]⁺. Complex 17 was prepared from the reaction of thiophenol with [(C₆H₆)RuCl₂]₂in refluxing ethanol (scheme in FIG. 5).

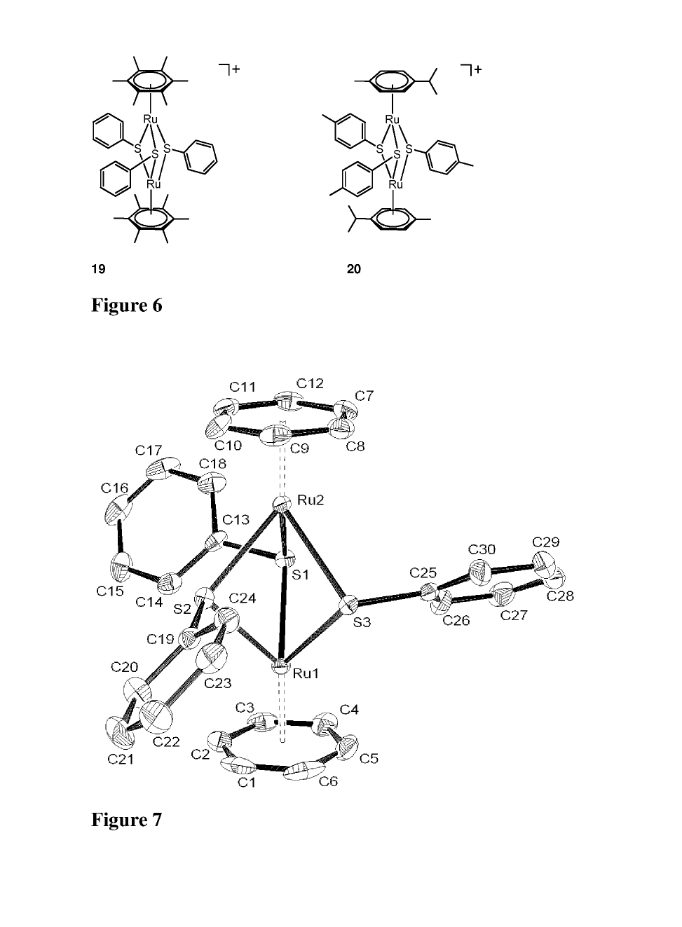

The known p-cymene and hexamethylbenzene analogs [(p-ⁱPrC₆H₄Me)₂Ru₂(SPh)₃]⁺ (18) (K. Mashima et al., Chem. Lett., 1992, 1795), [(C₆Me₆)₂Ru₂(SPh)₃]⁺ (19) (H. T. Schacht et al., Inorg. Chem., 1992, 31, 1728) (see FIG. 6) and [(p-ⁱPrC₆H₄Me)₂Ru₂(S-p-C₆H₄Me)₃]⁺ (20) (F. Chérioux et al., Chem. Eur. J., 2002, 19, 4377) were also synthesised according to this method which gives much better yields than the reported procedures. All the complexes were isolated as the chloride salts.

Compound [17]Cl, an air-stable yellow solid soluble in water and in organic solvents, gives rise to two signals for the three equivalent thiophenolato groups (7.37 m and 7.83 d ppm) and to a singlet for the two equivalent benzene ligands (5.44 ppm) in the ¹H NMR spectrum. The ESI mass spectrum shows the molecular peak at m/z 686.94. The spectroscopic data for the analogues [18]Cl, [19]Cl and [20]Cl is in excellent agreement with that reported previously Mashima et al., Schacht et al. Chérioux et al., cited above).

The molecular structure of 17 was established by single-crystal X-ray diffraction analysis of the PF₆⁻ salt. The unit cell contains two independent cations (molecules A and B), the bond distances and angles being similar. An ORTEP drawing with the atom labelling scheme for molecule A of cation 17 is shown in FIG. 7 and selected bond lengths and angles are given in Table 1 below. The structure contains a trigonal bipyramidal Ru₂S₃ framework, in which each ruthenium atom adopts a pseudo-octahedral geometry due to the three sulfur atoms and the benzene ligand that formally occupies three coordination sites.

TABLE 1
Selected bond lengths (Å) and angles (°) for cation 17.

| | |
|---|---|
| Molecule A | Molecule B |

Interatomic distances

| | | |
|---|---|---|
| Ru—S | 2.3764(12) | 2.3823(13) |
| | 2.3858(12) | 2.3828(13) |
| | 2.4014(12) | 2.3866(14) |
| | 2.4019(13) | 2.3961(13) |
| | 2.4112(12) | 2.4043(13) |
| | 2.4239(12) | 2.4119(14) |
| S—Cₚₕ | 1.793(5) | 1.792(5) |
| | 1.795(5) | 1.795(5) |
| | 1.798(5) | 1.796(6) |
| Ru-centroid | 1.704 | 1.695 |
| | 1.705 | 1.698 |

Angles

| | | |
|---|---|---|
| Ru—S—Ru | 88.17(4) | 88.58(4) |
| | 88.48(4) | 88.67(4) |
| | 89.67(4) | 88.96(4) |

The Ru—S bond distances in the cation 17 range from 2.3764(12) to 2.4239(12) Å and the Ru—S—Ru angles range from 88.17(4) to 89.67(4)°, similar to those found in the known p-cymene and hexamethylbenzene derivatives [(p-ⁱPrC₆H₄Me)₂Ru₂(SPh)₃]⁺ (18) and [(C₆Me₆)₂Ru₂(SPh)₃]⁺ (19), but slightly longer than in a thiopyrone complex (W. Kandioller, et al., Organometallics, 2009, 28, 4249). In accordance with the electron count, the Ru—Ru distances (3.3576(5) and 3.3481(6)Å) are clearly outside of the range for a metal-metal single bond (2.28-2.95 Å) (W. H. Ang, et al., Angew. Chem. Int. Ed., 2009, 48, 3854).

The three phenyl groups are not in the plane formed by the three sulfur atoms. The difference between the two independent molecules resides in the relative tilt of the phenyl groups with respect to this plane; in molecule A two phenyl groups are tilted to the right and the third phenyl group is tilted to the left whereas the tilts are opposite in molecule B.

The dinuclear dichloro complex [(arene)₂RuCl₂]₂ (0.20 mmol, 100 mg for 17; 122 mg for 18; 133 mg for 19) was refluxed in technical grade EtOH (50 mL). As soon as the starting material was dissolved, a solution of thiophenol (1.2 mmol, 132 mg, 123 μL) in technical grade EtOH (5 mL) was added dropwise to the hot solution. The resulting mixture was refluxed in EtOH for 18 h. After cooling to 20° C., the solvent was removed under reduced pressure. The mixture was purified by column chromatography (silica gel, CH₂Cl₂/EtOH 5:1) and [17-19]C1 were isolated as air-stable yellow to red crystalline solids and dried in vacuo.

[17]Cl. Yellow solid, yield: 129 mg, 88%. ¹H NMR (400 MHz, CDCl₃): 5.44 (s, 12H, H—Ar), 7.37 (m, 9H, H—Ar), 7.83 ppm (d, 6H, H—Ar). ¹³C{¹H}NMR (100 MHz, CDCl₃): δ6.55, 128.32, 129.61, 132.05, 139.22 ppm. Mass (ESI, m/z): 686.94 [M+H⁺]. Anal Calc. for (%): C₃₀H₂₇ClRu₂S₃: C, 49.95; H, 3.77. Found: C, 49.85; H, 3.70.

[18]Cl. Orange solid, yield: 155 mg, 93%. ¹H NMR (400 MHz, CDCl₃): 0.78 (d, ³J=8 Hz, 12H, (CH₃)₂CH), 1.57 (s, 6H, CH₃), 1.86 (sept, ³J=7.2 Hz, 2H, (CH₃)₂CH), 5.05 (d, ³J=8 Hz, 2H, H—Ar), 5.08 (d, ³J=8 Hz, 2H, H—Ar), 5.19 (d, 2H, H—Ar), 5.36 (d, 2H, H—Ar), 7.34 (m, 9H, H—Ar), 7.84 ppm (d, 6H, H—Ar). ¹³C{H}NMR (100 MHz, CDCl₃): 17.71, 21.95, 22.53, 30.58, 83.65, 84.76, 85.03, 85.37, 99.97, 107.39, 128.45, 129.19, 132.57, 137.81 ppm. Mass (ESI, m/z): 799.07 [M+H⁺]. Anal Calc. for (%): C₃₈H₄₃ClRu₂S₃: C, 54.76; H, 5.20. Found: C, 54.69; H, 5.32.

[19]Cl. Red solid, yield: 162 mg, 91%. ¹H NMR (400 MHz, CDCl₃): 2.02 (s, 36H, CH₃), 7.36 (m, 9H, H—Ar), 7.87 ppm (d, 6H, H—Ar). ¹³C{¹H}NMR (100 MHz, CDCl₃): 14.99, 97.82, 128.42, 129.53, 132.15, 138.32 ppm. Mass (ESI, m/z): 855.13 [M+H⁺]. Anal Calc. for (%): C₄₂H₅₁C1Ru₂S₃: C, 56.70; H, 5.78. Found: C, 56.65; H, 5.70.

### Example 6

### Biological Activity Towards Human Ovarian Cancer Cells

### 1. Cell Culture and Inhibition of Cell Growth

Human A2780 and A2780cisR ovarian carcinoma cells were obtained from the European Centre of Cell Cultures (ECACC, Salisbury, UK) and maintained in culture as described by the provider. The cells were routinely grown in RPMI 1640 medium with GlutaMAX™ containing 5% foetal calf serum (FCS) and antibiotics (penicillin and streptomycin) at 37° C. and 5% CO₂.

The antiproliferative activity of complexes 9-20 was evaluated against the human ovarian A2780 cancer cell line and its cisplatin-resistant derivative A2780cisR using the MTT assay, which measures mitochondrial dehydrogenase activity as an indication of cell viability. For the evaluation of growth inhibition tests, the cells were seeded in 96-well plates (25×10³ cells per well) and grown for 24 h in complete medium. Complexes were dissolved in DMSO and added to the required concentration to the cell culture for 72 h incubation. Solutions of the compounds were applied by diluting a freshly prepared stock solution of the corresponding compound in aqueous RPMI medium with GlutaMAX™ (20 mM). Following drug exposure, 3-(4,5-dimethylthiazol-2-yl)-2,5-diphenyltetrazolium bromide (MTT) was added to the cells at a final concentration of 0.25 mg/mL and incubated for 2 h, then the culture medium was aspirated and the violet formazan (artificial chromogenic precipitate of the reduction of tetrazolium salts by dehydrogenases and reductases) dissolved in DMSO. The optical density of each well (96-well plates) was quantified three times in triplicates at 540 nm using a multiwall plate reader (iEMS Reader MF, Labsystems, US), and the percentage of surviving cells was calculated from the ratio of absorbance of treated to untreated cells. The IC₅₀ values for the inhibition of cell growth were determined by fitting the plot of the logarithmic percentage of surviving cells against the logarithm of drug concentration using a linear regression function. The median value and the median absolute deviation were obtained from the Excel™ software (Microsoft™) and those values are reported in Table 2.

### 2. Results and Discussion

The IC₅₀ values of 9-20, corresponding to inhibition of cancer cell growth at the 50% level, are listed in Table 2 below.

TABLE 2
IC₅₀ values of complexes 9-20 towards A2780
and A2780cisR human ovarian cancer cells.

| | IC₅₀ (μM) | IC₅₀ (μM) |
|---|---|---|
| Compound | A2780 | A2780cisR |
| [9]Cl | 2.2 | 2.7 |
| [10]Cl | 4.9 | 5.6 |
| [11]Cl | 0.82 | 1.36 |
| [12]Cl | 0.49 | 0.56 |
| [13]Cl | 127 | 132 |
| [14]Cl | 130 | 126 |
| [15]Cl | 113 | 104 |
| [16]Cl | 13.6 | 27.2 |
| [17]C1 | 0.38 | 0.48 |
| [18]C1 | 0.24 | 0.25 |
| [19]Cl | 0.4 | 1.2 |
| [20]C1 | 0.13 | 0.08 |

The complexes tested show a broad range of cytotoxicities, depending on both the thiophenyl and arene substituents, but with comparable effects on both the cisplatin sensitive and resistant cell lines. More precisely, two general tendencies can be appreciated from the data. First, the arene ruthenium thiophenato complexes (9 to 12) are systematically more cytotoxic than their hydroxyl-thiophenato analogues (13 to 16). Second, the arene moiety have an effect, as shown by the diversity of toxicities observed for compounds 9, 10, 17, 18, 19 and 20, although the IC₅₀ values obtained cannot be precisely correlated to the lipophilicity or the size of the substituents. It is worth noting that the sub-micromolar cytotoxicites observed for some of these compounds place them amongst the most cytotoxic arene ruthenium compounds reported, even based on the fact that two ruthenium centers are present.

The stability of the most active complex [(p-ⁱPrC₆H₄Me)₂Ru₂(S-p-C₆H₄Me)₃]⁺ (20) was assessed using ¹H NMR spectroscopy over 12 hours at 37° C. in DMSO-d₆, in D₂O/DMSO-d₆ (95:5), and in DMSO-d₆ in the presence of two drops of RPMI 1640 medium with GlutaMAX™ containing 5% foetal calf serum and penicillin and streptomycin antibiotics to mimic pseudo-physiological conditions. The ¹H NMR signals of 20 did not change at all during 12 hour period which indicates that it is stable under these conditions.

In conclusion, a series of highly cytotoxic cationic diruthenium complexes of general formula [(arene)₂Ru₂(SPh)₃]⁺ have been prepared. Without wishing to be bound by theory, the high in vitro anticancer activity of these complexes could be ascribed, at least in part, to the presence of the thiophenolato groups. Further work is required to delineate the mode of action of these compounds and to develop further derivatives in order to understand the role of the bridging thiolato, in particular thiophenolato, selenolato, alkoxo and/or amido ligands.

### Example 7

### Synthesis of Further Unfunctionalized Arene Ruthenium(II) Mercaptophenol Complexes in Accordance with the Inventions

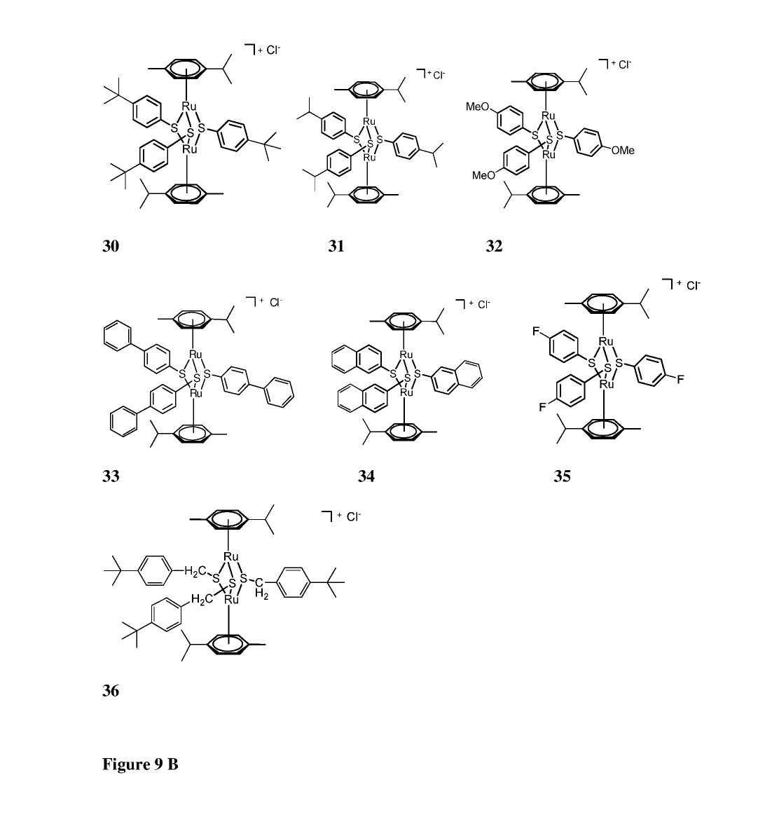

The chloride salts of compounds 21 ([Ru₂(p-MeC₆H₄Prⁱ)₂(p-SC₆H₄OH)₃]⁺, FIG. 9A) and 22 [Ru₂(p-C₆Me₆)₂(p-SC₆H₄OH)₃]⁺, respectively, were prepared as disclosed in Chérioux et. al., Polyhedron 22 (2003) 543-548.

### Example 8

### Synthesis of Prior Art Pentamethylcyclopentadienyl-Based Diruthenium (III) Complexes as Disclosed in JP 7089855 and JP 7089974

The chloride salts of prior art compounds PA1, PA2: [(CₛMes)₂Ru₂(p-SC₆H₅)₃]⁺ and [(CsMe₅)₂Ru₂(p-SC₆H₄Me)₃]⁺, respectively, were prepared as disclosed by Somanath Dev, Kiyomi Imagawa, Yasushi Mizobe, Guobao Cheng, Yasuo Wakatsuki, Hiroshi Yamasaki and Masanobu Hidai “Preparation, Properties and Some Reactions of Novel Ruthenium Thiolate Complexes”, Organometallics 1989, 8, 1232-1237. In JP 7089855, compound PA1 was shown to have and IC₅₀ value of 0.131 mg/mL in an MTT assay using PLC/PRF/5 human liver cancer cells. The toxicity of these compounds was assessed in Example 10 below.

### Example 9

### Synthesis of Neutral Dithiolato Diruthenium (II) Complexes in Accordance with the Invention

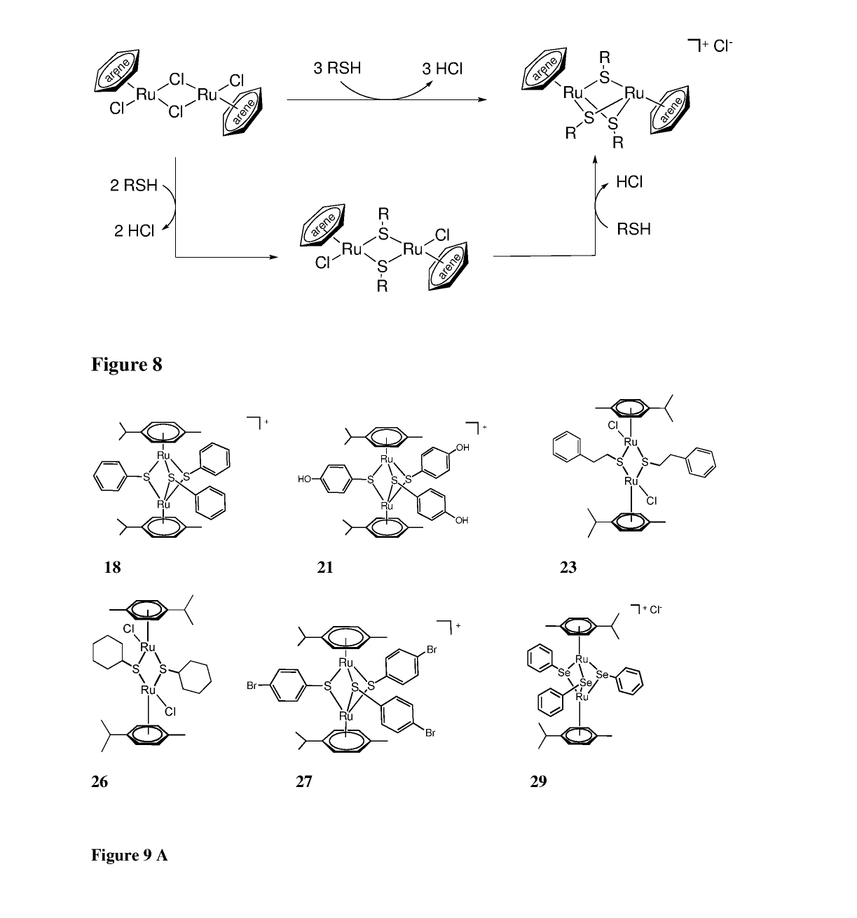

Compounds of the structure [(p-MeC₆H₄Pr)₂Ru₂(SR)₂Cl₂], with R=—CH₂—CH₂—C₆H₅(23) (FIG. 9A), —CH₂—C₆H₅(24), —CH₂—C₆H₄-p-Bu^{t} (25), and —C₆H₁₁ (cyclohexyl) (26) (FIG. 9A) were synthesized as illustrated in the lower reaction pathway of FIG. 8 and as described below.

The dinuclear dichloro complex [(η⁶-PrⁱC₆H₄Me)RuCl₂]₂ (1 equivalent) was added in 10 mL of technical EtOH. When the complex was completely dissolved, the solution was colded at 0° C. and a solution of the thiol (HSR, 2 equivalents) was added drop-wise to the cold solution. The resulting mixture was stirred in EtOH for 2 h. After 2 h, 30 mL of diethylether was added and the reaction was cooling to −18° C. during 24 h. The resulting compound ([(η⁶-PrⁱC₆H₄Me)₂Ru₂(SR)₂Cl₂ was isolated by purification with canula as a powder. The reaction scheme works for many R and arenes and was conducted for R=cyclohexanyl (23), 2-phenyl-ethenyl (26), and further compounds.

### Example 10

### Activity Against A2780 Cancer Cells of Compounds of the Invention and Prior Art Compounds

The toxicity of further compounds in accordance with the invention shown in FIGS. 9A and 9B and of the prior art compounds PA1 and PA2 was assessed as described in Example 6. The results are shown in Table 3 below.

TABLE 3
IC50 values of complexes as listed towards A2780
and A2780cisR human ovarian cancer cells

| | Average IC50 | |
|---|---|---|
| Compound | A2780 | A2780cisR |
| 11 | 0.815 | 1.360 |
| 12 | 0.420 | 0.545 |
| 17 | 0.377 | 0.477 |
| 17 | 0.240 | 0.253 |
| 19 | 0.433 | 1.200 |
| 21 | 0.533 | 1.467 |
| 22 | 0.500 | 0.500 |
| 20 | 0.130 | 0.077 |
| 27 | 0.250 | 0.260 |
| 28 | 0.155 | 0.168 |
| 29 | 0.532 | 0.578 |
| 30 | 0.030 | 0.035 |
| 31 | 0.080 | 0.052 |
| 32 | 0.175 | 0.145 |
| 33 | 0.275 | 0.105 |
| 34 | 0.105 | 0.195 |
| 35 | 0.660 | 1.050 |
| 23 | 0.201 | 0.307 |
| 26 | 0.464 | 0.676 |
| PA1 | 3.053 | 2.191 |
| PA2 | 1.934 | 1.551 |
| 36 | <0.2 | <0.2 |
| 37 | <0.2 | <0.2 |

### Example 11

### Catalytic Activity of the Complexes of the Invention

In order to assess the activity of the complexes of the invention, the most active complex, [(p-ⁱPrC₆H₄Me)₂—Ru₂(S-p-C₆H₄Me)₃]⁺ was exposed to various substrates in aqueous solution and the compound was found to catalyse the reaction of Cysteine (Cys) to form Cystine and of Glutathione (GSH) to form glutathione disulfide (GSSG) with very high efficiency.

According to an embodiment, the complexes of the invention are used as catalysts of the oxidation of free —SH bonds, for example occurring in proteins and amino acids, but in particular of Cys and glutathione (GSH), wherein Cys may be free or protein bound. This catalytic activity may be related to the high cytotoxicity found against ovarian cancer cells.

According to an embodiment, the complexes of the invention are used as catalysts for the formation of disulfide bonds in compounds having free —SH groups.

According to an embodiment, the complexes of the invention are used as catalysts for the oxidative, covalent binding of two compounds having each a free —SH group, in particular by the formation of a disulfide bond (—S—S—).

Coordination of Cys and GSH to the complexes was not observed, showing the complex acts solely as a catalyst. Furthermore, the catalyst can be reused several times without significant changes of the turn over numbers and turn over frequencies. This is different from the results reported by S. J. Dougan et al., P Natl Acad Sci USA (PNAS), 2008, 105, no. 33, 11628-11633 and from F. Wang et al., Inorg. Chem. 2002, 41, 4509-4523.

Furthermore, no interactions with all other amino acids and with nucleotides could be evidenced, suggesting that this complex does not strongly interact with proteins or DNA, as do many metal based anticancer drugs

1-23. (canceled)

24: A method of treating a hyperproliferative disorder in an individual in need of such treatment, the method comprising the step of administrating to the individual a complex comprising a structure of any one selected from formula (IIa) and formula (IIb): 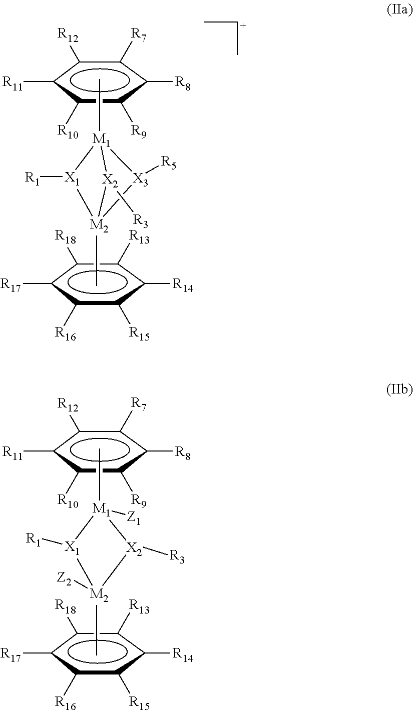
wherein M₁ and M₂ are a Ru(II) metal atoms;
wherein R₇, R₈, R₉, R₁₀, R₁₁, R₁₂, R₁₃, R₁₄, R₁₅, R₁₆, R₁₇, and R₁₈ are independently selected from H and from C1-C20 hydrocarbons optionally comprising 0-15 heteroatoms, halogens, hydroxyl, carboxylic acid group, carbonyl, nitro and amino;
wherein X₁, X₂, and X₃ are, independently, selected from S, Se, and O;
Z₁ and Z₂ are independently selected from halogen;
wherein R₁, R₃, and R₅, in as far as present, are selected, independently, from H, and from C1-C30 hydrocarbons optionally comprising 0-20 heteroatoms, said hydrocarbons being selected from:
substituted or unsubstituted aryls;
substituted or unsubstituted aliphatic substituents; and
substituents derived independently from a natural compound and/or a bioactive compound;
wherein substituents of said aryl and aliphatic substituent, if present, may be selected independently from C1-C20 hydrocarbons comprising 0-15 heteroatoms, halogens, hydroxy, carboxylic acid group, nitro and amino, and wherein two substituents provided on different carbons of said aryl or aliphatic substituent may be connected so as to form one or more ring fused to said aryl or aliphatic substituent.

25. The method of claim 24,
wherein X₁, X₂ and X₃ are selected from S and Se;
wherein substituents R₇, R₈, R₉, R₁₀, R₁₁, R₁₂, R₁₃, R₁₄, R₁₅, R₁₆, R₁₇, and R₁₈ are selected, independently, from:
C4-C20 hydrocarbons optionally comprising 0-15 heteroatoms, with the proviso that said C4-C20 hydrocarbon optionally comprising 0-15 heteroatoms comprises at least one aromatic ring or ring system and/or comprises at least one bioactive moiety, and further from:
H, halogens, hydroxyl, carboxylic acid group, nitro and amino, C1-C10 alkyls, C2-C10 alkenyls, C2-C10 alkynyls, C4-C10 aryl, C1-C10 alkoxyl, C2-C10 alkenoxyl, C2-C10 alkynoxyl, C4-C10 aryloxyl, wherein said alkyl, alkoxyl, alkenyl, alkenoxyl, alkynyl, alkynoxyl, may be totally or partially halogenated and may be linear or branched, wherein said aryl and/or an aryl moiety of said aryloxyl, if it is a C4 or a C5 aryl and/or aryloxyl, respectively, it comprises at least on heteroatom, wherein said aryl and aryloxyl may be further substituted, besides with halogen, with C1-C4 alkyl, and wherein substituents on neighbouring carbons of any one or both of the benzene rings in formula (IIa) or (IIb) may be linked so as to form one or more rings fused to said benzene ring.

26. The method of claim 24, wherein X₁, X₂ and X₃ are S.

27. The method of claim 24, wherein, in said R₁, R₃, and R₅, in as far as present,
said aryl is a substituted or unsubstituted phenyl;
said aliphatic substituent is selected from C1-C10 alkyl, C2-C10 alkenyl, C2-C10 alkynyl, wherein said alkyl, alkenyl and alkynyl may be substituted and may be linear and, if it comprises at least three carbons, also branched and/or cyclic and, wherein, in said alkyl, alkenyl ad alkynyl, one or more carbons may be replaced by heteroatoms;
wherein substituents of said phenyl, alkyl, alkenyl, and alkynyl, if present, may be independently selected from halogen, —OH, —COOH, C1-C20 hydrocarbons optionally comprising 0-15 heteroatoms.

28. The method of claim 27, wherein optional substituents of said phenyl, alkyl, alkenyl, and alkynyl, if present, are selected from:
halogen;
—R₃₀;
—O—R₃₀;
—O—R₃₅;
wherein R₃₀ is independently selected from C1-C8 alkyls, C2-C8 alkenyls, and C2-C8 alkynyls, which, independently, may be linear, and if comprising more than three carbons, branched or cyclic, and which may be totally or partially halogenated, and from substituents of formula (V) below: 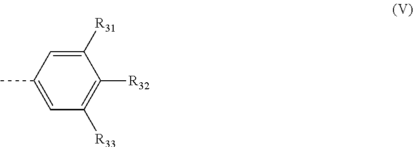
wherein R₃₅ is derived from a C3-C20 hydrocarbon compound comprising 1 to 15 heteroatoms, said compound being selected from natural compounds and bioactive compounds comprising at least one carboxylic acid group forming, in said substituent R₃₅, an ester bond with the oxygen atom of said —O—R₃₅ substituent;
wherein R₃₁, R₃₂, R₃₃ are, independently, selected from:
H;
halogen;
C1-C8 alkyl, C2-C8 alkenyl, C2-C8 alkynyl, which may linear or, if comprising three or more carbons, branched and cyclic, wherein said alkyls, alkenyls and alkynyl may be totally or partially halogenated; and,
substituents —O—R₃₅.

29. The method of claim 24, wherein, if any one of said substituents R₁, R₃, and R₅ is derived from a natural compound and/or bioactive compound, said compound comprises at least one ligand group selected from HS—, HSe—, HO—, or wherein said natural or bioactive compound is covalently connected to a linker moiety comprising one of the aforementioned ligand groups, the linker moiety comprising, said ligand group included, 1-10 carbons and 1-5 heteroatoms, and wherein, in said substituent derived from a natural compound and/or a bioactive compound, the sulphur, selenium, or oxygen group of said HS—, HSe—, or HO— group, respectively, constitutes one or more of X₁, X₂, and X₃ in the complex.

30. The method of claim 24, wherein R₁, R₃, and R₅, in as far as present, are selected from substituted or unsubstituted C6-C12 aryls, (in particular phenyl and naphthyl) and C1-C10 linear, branched or cyclic alkyls, wherein said aryls and alkyls may be further substituted.

31. The method of claim 30, wherein said optional further substituents of said aryl and alkyl may be selected from —OH, —COOH, halogen, —R₃₀; and —O—R₃₀, and from substituents of formula (V), wherein —R₃₀ is selected from C1-C8 alkyls, and R₃₁, R₃₂, R₃₃ are, independently, selected from: H; halogen; C1-C8 alkyl, linear or cyclic C2-C8 alkenyl, and wherein substituents of said aryl and cyclic alkyl may be connected to each other to form a ring, which may be fused to said aryl or cyclic aliphatic substituent.

32. The method of claim 24, wherein said complex comprises a structure of formula (IVa) or (IVb): 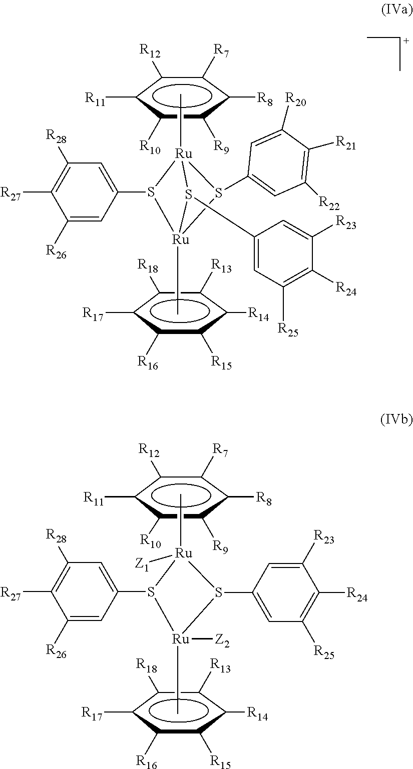
wherein:
R₇, R₈, R₉, R₁₀, R₁₁, R₁₂, R₁₃, R₁₄, R₁₅, R₁₆, R₁₇, and R₁₈ are selected, independently, from: C4-C20 hydrocarbons optionally comprising 0-15 heteroatoms, with the proviso that said C4-C20 hydrocarbon optionally comprising 0-15 heteroatoms comprises at least one aromatic ring or ring system and/or comprises at least one bioactive moiety, and further from:
H, halogens, hydroxyl, carboxylic acid group, nitro and amino, C1-C10 alkyls, C2-C10 alkenyls, C2-C10 alkynyls, C4-C10 aryl, C1-C10 alkoxyl, C2-C10 alkenoxyl, C2-C10 alkynoxyl, C4-C10 aryloxyl, wherein said alkyl, alkoxyl, alkenyl, alkenoxyl, alkynyl, alkynoxyl, may be totally or partially halogenated and may be linear or branched, wherein said aryl and/or an aryl moiety of said aryloxyl, if it is a C4 or a C5 aryl and/or aryloxyl, respectively, it comprises at least on heteroatom, wherein said aryl and aryloxyl may be further substituted, besides with halogen, with C1-C4 alkyl, and wherein substituents on neighbouring carbons of any one or both of the benzene rings in formula (IIa) or (IIb) may be linked so as to form one or more rings fused to said benzene ring;
R₂₀, R₂₁, R₂₂ R₂₃, R₂₄, R₂₅, R₂₆, R₂₇, R₂₈, in as far as present, are independently selected from H, halogen, —R₃₀, —O—R₃₀, —O—R₃₅, wherein:
R₃₀ is independently selected from C1-C8 alkyls, C2-C8 alkenyls, and C2-C8 alkynyls, which, independently, may be linear, and if comprising more than three carbons, branched or cyclic, and which may be totally or partially halogenated, and from substituents of formula (V) below: 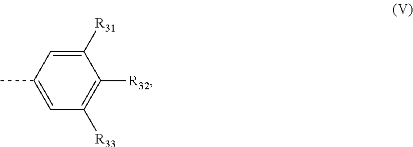
and,
R₃₅ is derived from a C3-C20 hydrocarbon compound comprising 1 to 15 heteroatoms, said compound being selected from natural compounds and bioactive compounds comprising at least one carboxylic acid group forming, in said substituent R₃₅, an ester bond with the oxygen atom of said —O—R₃₅ substituent;
wherein R₃₁, R₃₂, R₃₃ are, independently, selected from:
H;
halogen;
C1-C8 alkyl, C2-C8 alkenyl, C2-C8 alkynyl, which may linear or, if comprising three or more carbons, branched and cyclic, wherein said alkyls, alkenyls and alkynyl may be totally or partially halogenated; and,
substituents —O—R₃₅.

33. The method of claim 28, wherein R₃₅ is derived from any one compound selected from isonicotinic acid, ethacrynic acid, folic acid, biotin, pyridoxol-5-phosphate hydrate, wherein any carboxylic acid group of said compound forms an ester bond with the oxygen atom of the —O—R₃₅ substituent.

34. The method of claim 32, wherein R₂₀, R₂₁, R₂₂, R₂₃, R₂₄, R₂₅, R₂₆, R₂₇, R₂₈, in as far as present, are selected from H, halogen, C1-C4 alkyl, wherein said alkyl, if it has 3 or 4 carbons, may be branched.

35. The method of claim 24, wherein:
R₇, R₈, R₉, R₁₀, R₁₁, R₁₂, R₁₃, R₁₄, R₁₅, R₁₆, R₁₇, and R₁₈ are independently selected from: H, halogens, hydroxyl, carboxylic acid group, nitro and amino, C1-C8 alkyls, C2-C8 alkenyls, C2-C8 alkynyls, C4-C8 aryl, C1-C8 alkoxyl, C2-C8 alkenoxyl, C2-C8 alkynoxyl, C4-C10 aryloxyl, all of which may be totally or partially halogenated and wherein said alkyl, alkoxyl, alkenyl, alkenoxyl, alkynyl, alkynoxyl, and aryloxyl may be linear or branched, wherein, if said aryl and/or an aryl moiety of said aryloxyl, if it is a C4 or a C5 aryl and/or aryloxyl, respectively, it comprises at least on heteroatom, and wherein substituents on neighbouring carbons of a given benzene ring in the structure of formulae (IIa), (IIb), (IVa) or (IVb), as applicable, which benzene ring carries R₇—R₁₂ or R₁₃—R₁₈, respectively, may be connected so as to form one or more rings fused to said benzene ring.

36. The method of claim 24, wherein at least one of R₇, R₈, R₉, R₁₀, R₁₁, and R₁₂ is H and/or at least one of R₁₃, R₁₄, R₁₅, R₁₆, R₁₇, and R₁₈, is H.

37. The method of claim 24, wherein at least one of R₇, R₈, R₉, R₁₀, R₁₁, and R₁₂ is a C3-C4 alkyl and/or at least one of R₁₃, R₁₄, R₁₅, R₁₆, R₁₇, and R₁₈, is a C3-4 alkyl.

38. The method of claim 24, wherein R₇, R₈, R₉, R₁₀, R₁₁, and R₁₂, are not all alkyl and/or wherein R₁₃, R₁₄, R₁₅, R₁₆, R₁₇, and R₁₈, are not all alkyl.

39. The method of claim 24, wherein R₇, R₈, R₉, R₁₀, R₁₁, and R₁₂, are not all methyl, and/or wherein R₁₃, R₁₄, R₁₅, R₁₆, R₁₇, and R₁₈, are not all methyl.

40. The method of claim 24, wherein at least one of R₇, R₈, R₉, R₁₀, R₁₁, and R₁₂, is H and at least one is alkyl; and/or wherein at least one of R₁₃, R₁₄, R₁₅, R₁₆, R₁₇, and R₁₈, is H and at least one is alkyl.

41. The method of claim 24, wherein R₇, R₈, R₉, R₁₀, R₁₁, and R₁₂, are all H, or one is isopropyl and one is methyl, the other substituents being H; and/or wherein R₁₃, R₁₄, R₁₅, R₁₆, R₁₇, and R₁₈, are independently selected such that are all H, or one is isopropyl and one is methyl.

42. The method of claim 24, wherein R₇, R₈, R₉, R₁₀, R₁₁, R₁₂, R₁₃, R₁₄, R₁₅, R₁₆, R₁₇, and R₁₈ are independently selected from:
H, C1-C5 alkyls, C2-C5 alkenyls, and C2-C5 alkynyls, wherein said alkyl, alkenyl and alkynyl may be linear or branched, and from:
—(CH₂)ₙ—O—C(O)—C₆H₄p-O—(CH₂)ₘCH₃,
—(CH₂)ₙ—O—C(O)—CH═CH—C₆H₄-p-O—CH₃,
wherein m is, independently, an integer of 1-6 and n being, independently, 1, 2, 3 or 4.

43. The method of claim 24, wherein said complex is [(arene)₂Ru₂(SR)₃]⁺ or [(arene)₂Ru₂(SR)₂Z₂], wherein:
arene is selected from C₆H₆(benzene), C₆H₅Me (methylbenzene), p-ⁱPrC₆H₄Me (p-cymene), C₉H₁₀ (indane), C₆H₆—(CH₂)ₙ—O—C(O)—C₆H₄-p-O—(CH₂)ₘCH₃, C₆H₆—(CH₂)ₙ—O—C(O)—CH═CH—C₆H₄-p-O—CH₃, with m being an integer of 1-6 and n being 1, 2, 3 or 4; and,
R is selected from phenyl and C1-C3 alkylphenyl, in particular p-C1-C3 alkylphenyl;
and Z, if present, is selected from Cl, Br, and I.

44. The method of claim 24, wherein said complex is selected from the group consisting of:
[(C₆H₆)₂Ru₂(SPh)₃]⁺,
[(C₆H₆)₂Ru₂(S-p-C₆H₄Me)₃]⁺,
[(C₆H₅Me)₂Ru₂(S—Ph)₃]⁺,
[(C₆H₅Me)₂Ru₂(S-p-C₆H₄Me)₃]⁺,
[(p-ⁱPrC₆H₄Me)₂Ru₂(SPh)₃]⁺,
[(p-ⁱPrC₆H₄Me)₂Ru₂(S-p-C₆H₄Me)₃]⁺,
[(C₆H₆—(CH₂)₂—O—C(O)—C₆H₄-p-O—(CH₂)₆CH₃)₂Ru₂(SPh)₃]⁺,
[(C₆H₆—(CH₂)₂—O—C(O)—C₆H₄-p-O—(CH₂)₆CH₃)₂Ru₂(S-p-C₆H₄Me)₃]⁺,
[(C₆H₆—(CH₂)₄—O—C(O)—C₆H₄-p-O—(CH₂)₆CH₃)₂Ru₂(SPh)₃]⁺,
[(C₆H₆—(CH₂)₄—O—C(O)—C₆H₄-p-O—(CH₂)₆CH₃)₂Ru₂(S-p-C₆H₄Me)₃]⁺,
[trans-(C₆H₆—(CH₂)₂—O—C(O)—CH═CH—C₆H₄-p-O—CH₃)₂Ru₂(SPh)₃]⁺,
[trans-(C₆H₆—(CH₂)₂—O—C(O)—CH═CH—C₆H₄-p-O—CH₃)₂Ru₂(S-p-C₆H₄Me)₃]⁺,
[trans-(C₆H₆—(CH₂)₄—O—C(O)—CH═CH—C₆H₄-p-O—CH₃)₂Ru₂(SPh)₃]⁺,
[trans-(C₆H₆—(CH₂)₄—O—C(O)—CH═CH—C₆H₄-p-O—CH₃)₂Ru₂(S-p-C₆H₄Me)₃]⁺,
[(C₆H₆)₂Ru₂(SPh)₂Z₂],
[(C₆H₆)₂Ru₂(S-p-C₆H₄Me)₂Z₂],
[(C₆H₅Me)₂Ru₂(S—Ph)₂Z₂],
[(C₆H₅Me)₂Ru₂(S-p-C₆H₄Me)₂Z₂],
[(p-ⁱPrC₆H₄Me)₂Ru₂(SPh)₂Z₂], and
[(p-ⁱPrC₆H₄Me)₂Ru₂(S-p-C₆H₄Me)₂ Z₂], wherein Z is halogen, preferably Cl.

45. The method of claim 24, wherein said hyperproliferative disorder is cancer.
